(19) United States
(12) Patent Application Publication
(10) Pub. No.: US 2026/0320822 A1
(43) Pub. Date: Oct. 15, 2026

(54) IMAGE PAIR LOCALIZATION FOR AUTONOMOUS AND SEMI-AUTONOMOUS SYSTEMS AND APPLICATIONS

(71) Applicant: NVIDIA Corporation, Santa Clara, CA (US)

(72) Inventors: Jun Liu, Irvine, CA (US); Di Zeng, Saratoga, CA (US); Yuchen Deng, Cupertino, CA (US); Chirag Ashokbhai Majithia, Santa Clara, CA (US); Rurui Ye, Shanghai (CN)

(21) Appl. No.: 19/174,798

(22) Filed: Apr. 9, 2025

Related U.S. Application Data
(63) Continuation of application No. 19/174,716, filed on Apr. 9, 2025.

(51) Int. Cl. G06T 7/73; G06T 7/80

(52) U.S. Cl. CPC G06T 7/74; G06T 7/85; G06T 2207/10012; G06T 2207/30244; G06T 2207/30252

(57) ABSTRACT

In various examples, stereo image localization for autonomous and/or semi-autonomous systems and applications is described herein. Systems and methods may perform localization using two images from a stereo camera along with a map image from a localization map. For instance, a respective relative pose between each of the images and the map image may be determined along with a relative pose between the images. The relative poses may then be used to determine a predicted pose—such as an estimated rotation and/or an estimated translation—between one of the images and the map image. Additionally, the predicted pose may be refined using one or more optimization techniques, such as by minimizing distances between feature points of the images and epipolar lines associated with the points. The refined pose between the images may then be used to determine a localized pose of the machine within the environment.

### CROSS-REFERENCE TO RELATED APPLICATIONS

This application is a continuation of U.S. patent application Ser. No. 19/174,716, filed Apr. 9, 2025, which is hereby incorporated by reference in its entirety.

### BACKGROUND

Localization is a vital process for autonomous and/or semi-autonomous functions of machines—such as vehicles, robots, drones, watercraft, and the like. For instance, after a machine is activated and/or moved to a new location within an environment, it is important that the machine performs localization to predict the pose (e.g., location and orientation) of the machine within the environment. This way, the machine is able to operate within the environment, such as to safely navigate around the environment without colliding with other objects and/or navigate to new locations within the environment. While machines are able to perform localization using location sensors—such as global positioning system (GPS) sensors—within outdoor environments to determine initial poses, machines may be unable to perform localization using the same sensors in indoor environments due to signal interference. As such, many techniques have been developed—such as Simultaneous Localization and Mapping (SLAM)—to perform image-based global localization within indoor environments.

More specifically, image-based global localization techniques include capturing images of an indoor environment and then storing the images along with corresponding poses in association with a localization map of the environment. Using the localization map, a machine then initially compares at least an image captured using an image sensor of the machine to the map images to identify at least one map image from the localization map that is related to the captured image. For instance, the machine may identify a map image that represents the same objects and/or features as the captured image. As such, based on the number of map images associated with a localization map, various techniques may be used to efficiently perform these processes of identifying map images from the localization map that are related to images captured by the machines.

For instance, bag-of-words (BOW) is used to generate global descriptions (e.g., BOW vectors) for images using a quantization of local features represented by the images, where the BOW vectors are used to search for relationships between images. More specifically, once the map images are captured for the localization map, local features are extracted from the map images and then clustered together to generate the visual words. A vocabulary dictionary of the visual words is then used to determine the BOW vectors for the images based on the local features. However, problems may occur when generating and/or utilizing the vocabulary dictionary of visual words. For instance, based on the number of extracted features from the map images, typical clustering techniques—such as K-Means Clustering—may be limited in the ability to adequately generate the vocabulary dictionary based on processing all of the features at a single session. Additionally, when new images of the environment are captured for the localization map—such as when the environment is updated—a new vocabulary dictionary needs to be generated using at least a portion of the previously map images along with the newly captured images.

Next, to perform the localization, conventional techniques may use a captured image from a machine and an identified map image from a localization map to predict the pose of the machine within the environment. For instance, a two-view based fundamental matrix geometry check may be used to determine relative rotation between the two views of the images by decomposing the fundamental matrix. However, while the relative rotation of the predicted pose may be estimated using such a process, the relative translation of the predicted pose may only be estimated up to a scale. As such, the conventional techniques may further perform landmark triangulation—such as by projecting three-dimensional (3D) landmarks with scaled 3D coordinates into the image planes—to estimate the final pose of the machine. However, performing landmark triangulation may introduce errors because it is not trivial to estimate 3D landmarks and/or because 3D landmarks that are adequate for rotation estimation may not be adequate for translation estimation.

### SUMMARY

Embodiments of the present disclosure relate to generating vocabulary dictionaries for localization in autonomous and/or semi-autonomous systems and applications. Systems and methods described herein may use multiple clustering techniques—such as K-Means Clustering, Balanced Iterative Reducing and Clustering using Hierarchies (BIRCH), and/or the like—to initially generate and/or update a vocabulary dictionary corresponding to an environment. For instance, using the clustering techniques, extracted features from initial images of a localization map may be used to generate a vocabulary tree corresponding to the vocabulary dictionary. Additionally, and again using the clustering techniques, extracted features from new images of the localization map may be used to update the vocabulary tree. In some examples, the systems and methods may further determine weights associated with the visual words from the vocabulary tree, such as by using algorithms that are optimized for indoor environments where multiple images may capture similar portions of the environment from similar poses.

In contrast to the conventional systems, the systems of the present disclosure, in some embodiments, use the different clustering techniques to both generate the vocabulary dictionary (e.g., the vocabulary tree) using initial images of the environment and then update the vocabulary dictionary as new images are captured of the environment. As such, the systems of the present disclosure may not need to generate entirely new vocabulary dictionaries whenever the new images are captured, which may save computing resources and/or time. Additionally, for similar reasons, the vocabulary dictionary may remain updated even when changes occur within the environment—such as portions of the environment being updated—which may cause the vocabulary dictionary to better represent the actual environment and/or increase the overall accuracy when performing localization using the vocabulary dictionary.

Additionally, embodiments of the present disclosure relate to image pair localization for autonomous and/or semi-autonomous systems and applications. Systems and methods described herein may perform localization using two images from a camera—such as a left image and a right image captured using a stereo camera, or generally two images captured using two camera with at least partially overlapping fields of view—along with a map image from a localization map. For instance, a respective relative pose between each of the images and the map image may be determined along with a relative pose between the images. The relative poses may then be used to determine one or more predicted poses—such as an estimated rotation and/or an estimated translation without scale ambiguity—between the images and the map image. Additionally, and as described in more detail herein, the systems and methods may refine the predicted pose(s) using one or more optimization techniques, such as by minimizing distances between feature points of the images and epipolar lines associated with the points. The predicted pose(s) and/or the refined pose(s) between the images may then be used to determine a localized pose of the machine within the environment.

In contrast to conventional systems, the systems of the present disclosure, in some embodiments, perform the localization using 2D observations from the image pairs along with the map image from the localization map. As such, the systems of the present disclosure may avoid performing 3D landmark triangulation similar to the conventional systems, which may be prone to errors. Additionally, in some embodiments, using the 2D observations to perform the localization by the systems of the present disclosure allows for a more accurate combination of translation estimation and rotation estimation as compared to 3D landmark triangulation. Furthermore, and as described in more detail herein, the systems of the present disclosure perform the optimization techniques to refine the predicted poses to further increase the overall accuracy of the localization.

### BRIEF DESCRIPTION OF THE DRAWINGS

The present systems and methods for generating and using vocabulary dictionaries for localization in autonomous and/or semi-autonomous systems and applications are described in detail below with reference to the attached drawing figures, wherein:

FIG. 1A illustrates an example data flow diagram for a process of generating a vocabulary dictionary that is used for performing localization in an environment, in accordance with some embodiments of the present disclosure;

FIG. 1B illustrates an example data flow diagram for a process of using a vocabulary dictionary and multiple images to perform localization, in accordance with some embodiments of the present disclosure;

FIG. 2 illustrates an example of capturing sensor data representing an environment, in accordance with some embodiments of the present disclosure;

FIG. 3 illustrates an example of extracting features from an image, in accordance with some embodiments of the present disclosure;

FIGS. 4A-4C illustrate an example of generating and then updating a vocabulary tree associated with an environment, in accordance with some embodiments of the present disclosure;

FIG. 5 illustrates an example of determining a global descriptor associated with an image, in accordance with some embodiments of the present disclosure;

FIGS. 6A-6B illustrate an example of a machine obtaining image data for performing localization within an environment, in accordance with some embodiments of the present disclosure;

FIG. 7 illustrates an example of identifying a map image that is related to a captured image when performing localization, in accordance with some embodiments of the present disclosure;

FIGS. 8A-8C illustrate an example of localizing a machine within an environment using stereo camera images, in accordance with some embodiments of the present disclosure;

FIG. 9 illustrates a flow diagram showing a method for using multiple clustering techniques to generate and update a vocabulary dictionary, in accordance with some embodiments of the present disclosure;

FIG. 10 illustrates a flow diagram showing a method for determining weights associated with visual words from a vocabulary dictionary, in accordance with some embodiments of the present disclosure;

FIG. 11 illustrates a flow diagram showing a method for using a pair of images to localize a machine within an environment, in accordance with some embodiments of the present disclosure;

FIG. 12A is an example of sensor locations having corresponding fields of view or sensory fields for example autonomous or semi-autonomous machines, in accordance with at least some embodiments of the present disclosure;

FIG. 12B is an illustration of an example of component and sensor locations on an autonomous or semi-autonomous vehicle, in accordance with at least some embodiments of the present disclosure;

FIG. 12C is a block diagram of an example system architecture for an autonomous or semi-autonomous vehicle, robot, and/or other machine type, in accordance with at least some embodiments of the present disclosure;

FIG. 12D is a block diagram of an example architecture of a computing system—such as a system-on-a-chip (SoC)—in accordance with at least some embodiments of the present disclosure;

FIG. 12E is a system diagram for communication between cloud-based server(s) and an example autonomous or semi-autonomous vehicle, robot, and/or other machine type, in accordance with at least some embodiments of the present disclosure;

FIG. 13 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 14 is a block diagram of an example computing system for generative artificial intelligence (AI), in accordance with at least some embodiments of the present disclosure; and

FIG. 15 is a block diagram of an example computing device, in accordance with at least some embodiments of the present disclosure.

### DETAILED DESCRIPTION

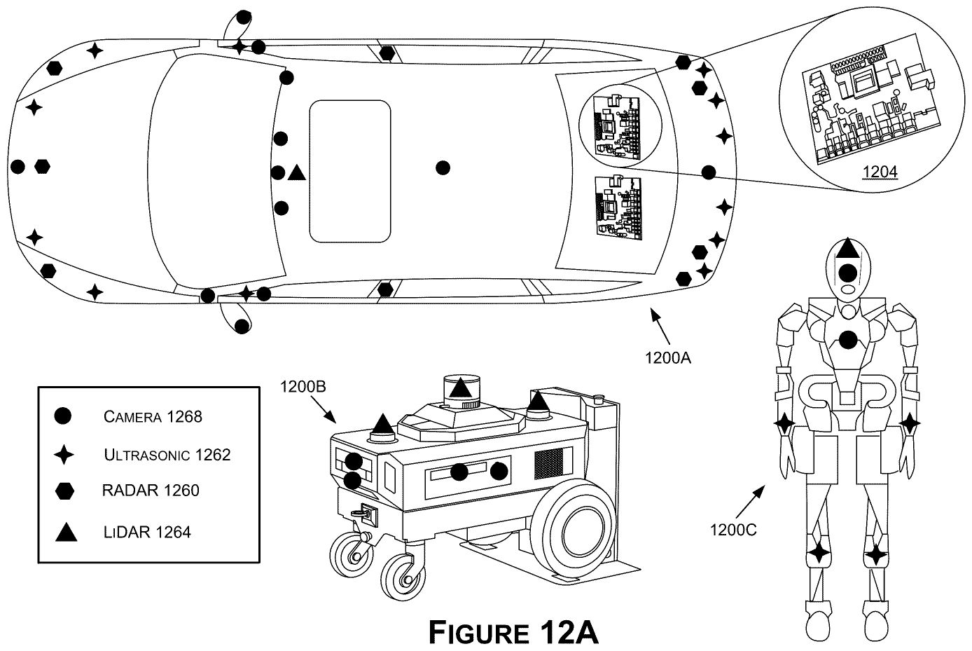

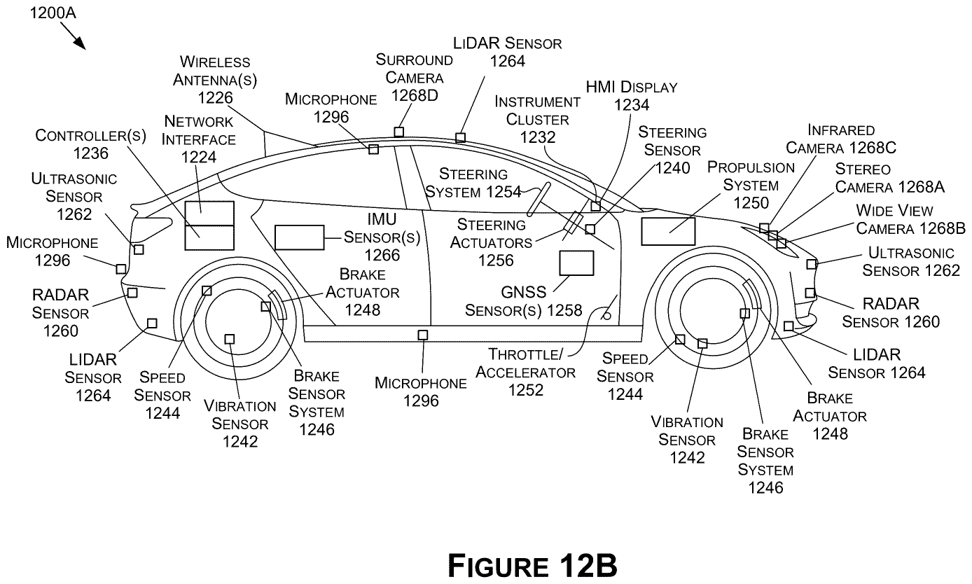

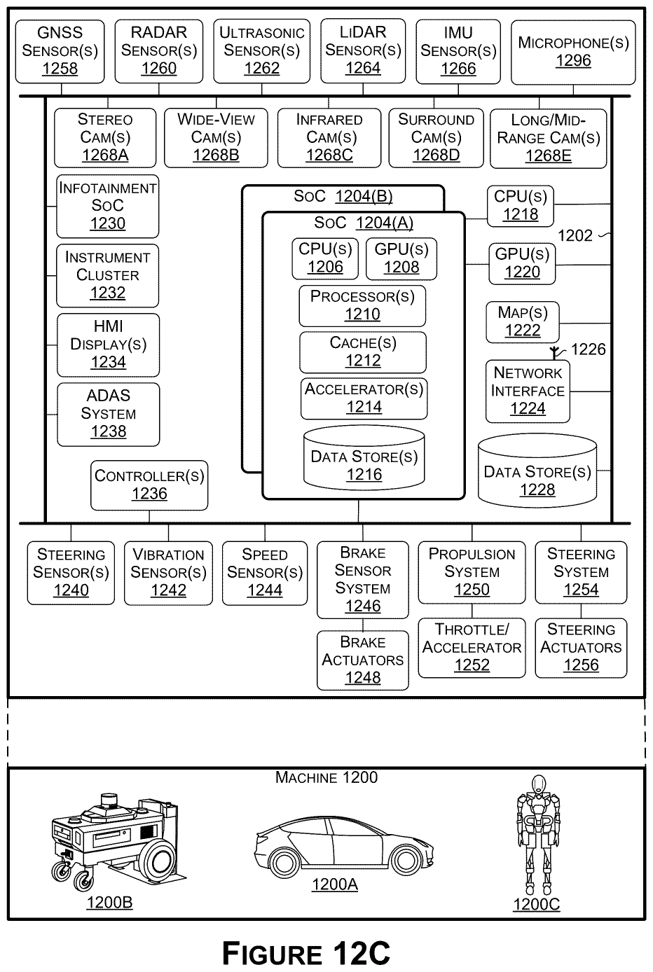

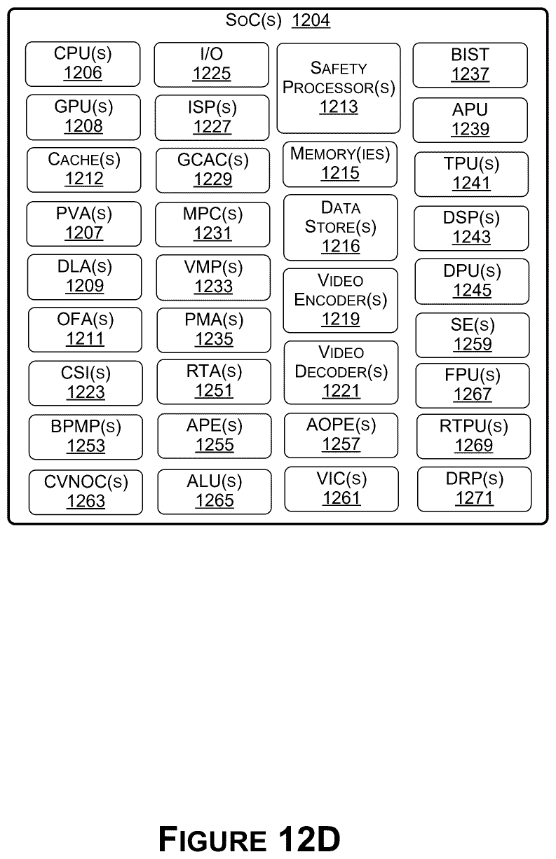

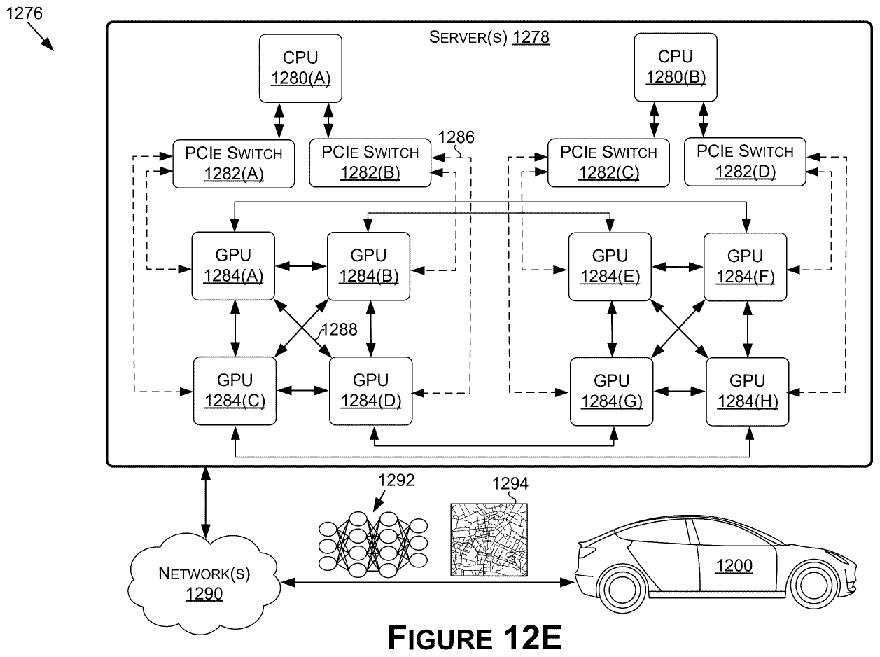

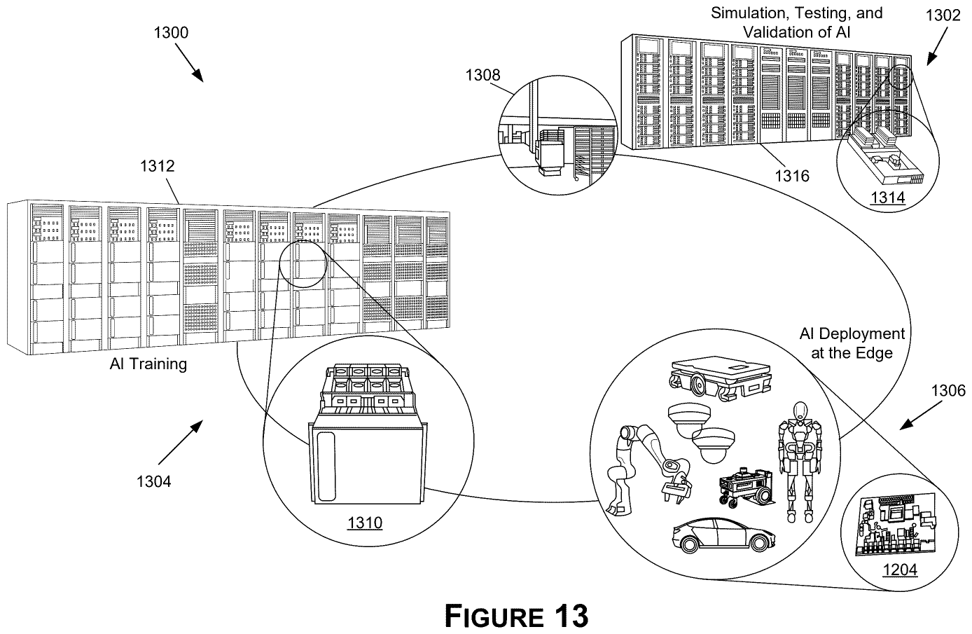

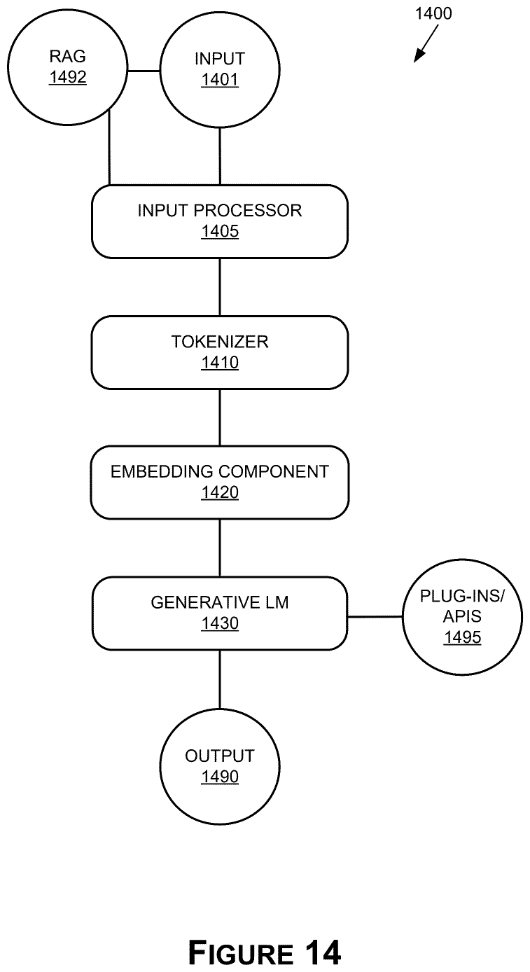

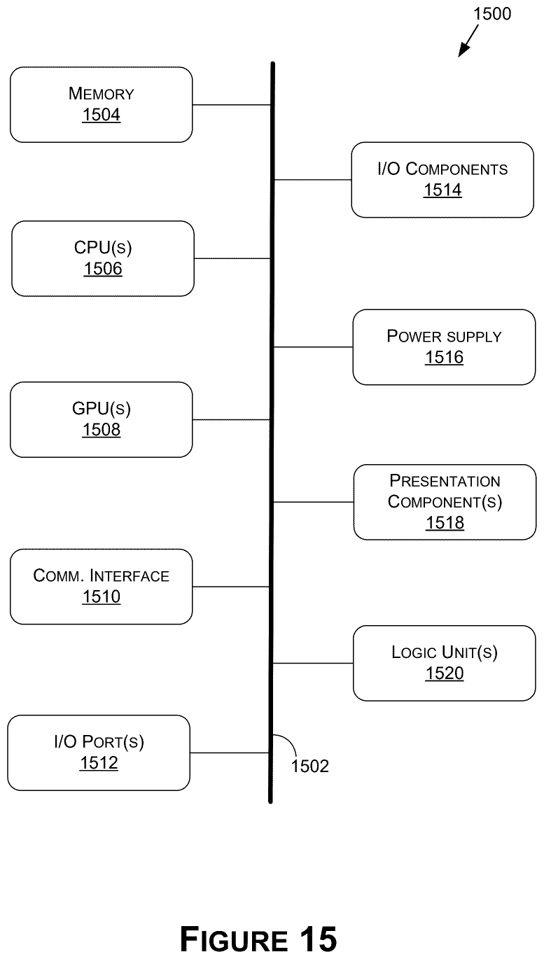

Systems and methods are disclosed for generating and using vocabulary dictionaries for localization in autonomous and/or semi-autonomous systems and applications. Although the present disclosure may be described with respect to an example autonomous or semi-autonomous vehicle, robot, and/or other machine type 1200 (alternatively referred to herein as “vehicle 1200,” “ego-vehicle 1200,” “machine 1200,” “ego-machine 1200,” “robot 1200,” and/or “ego-robot 1200,” an example of which is described with respect to FIGS. 12A-12E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to localization, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where localization may be used. In some embodiments, the systems, methods, and/or processes described herein may be executed using similar components, features, and/or functionality to those of example machine 1200 of FIGS. 12A-12E, example computing ecosystem 1300 of FIG. 13, example generative language model system 1400 of FIG. 14, and/or example computing device 1500 of FIG. 15.

For instance, a system(s) may receive sensor data obtained using one or more machines navigating within an environment. As described herein, the sensor data may include, but is not limited to, image data representing images of the environment, pose data representing poses of the machine(s) within the environment, motion data representing motion of the machine(s) within the environment, LiDAR data representing point clouds, and/or any other type of sensor data. Additionally, the environment may include an interior environment—such as a retail environment, a warehouse environment, an office environment, an educational environment, and/or any other type of interior environment—and/or the environment may include an outdoor environment. The system(s) may then use at least a portion of the sensor data to generate a localization map associated with the environment.

For instance, the system(s) may use at least the image data to generate a vocabulary dictionary associated with the environment, where the vocabulary dictionary is later used for performing localization. To generate the vocabulary dictionary, the system(s) may initially process the image data using one or more feature detection techniques to detect features within the images and/or generate descriptors associated with the features. As described herein, a feature detection technique may include, but is not limited to, scale-invariant feature transform (SIFT), Superpoint, Harris corner detection, FAST algorithm, and/or any other type of feature extraction technique. Additionally, a descriptor may include, but is not limited to, a vector representing a patch located around an extracted feature within an image. The system(s) may then use the descriptors associated with the features to determine visual words for the vocabulary dictionary.

For instance, the system(s) may use one or more clustering techniques—such as K-Means Clustering, BIRCH, and/or the like—to cluster the features (e.g., the descriptors) into cluster features associated with a vocabulary tree. For instance, the internal nodes of the vocabulary tree may represent cluster features, and the leaves of the vocabulary tree may represent visual words associated with the vocabulary dictionary. In some examples, an individual cluster feature may be associated with attributes, such as a number of data objects (e.g., a number of features and/or descriptors) within the cluster feature, a linear sum of the data objects in the cluster feature, and/or a squared sum of the data objects within the cluster feature. Additionally, a visual word may be determined using a cluster feature, such as by being defined as a center of the cluster feature (and/or using any other technique). In some examples, a user may set and/or the system(s) may determine one or more attributes of the vocabulary tree, such as a number of visual words, a maximum number of cluster features per node, a maximum radius of the leaves, and/or any other attribute.

As described herein, after initially generating the vocabulary tree, the system(s) may update the vocabulary tree using additional images from the received image data and/or using new images represented by newly received image data. For instance, when a new feature is received from an image, a node of the vocabulary tree is selected for addition of the new feature. In some examples, the node is selected as including an intermediate node that minimizes the distance at individual levels (e.g., each level) from the root to a leaf. Next, if the new feature would cause the leaf to exceed the maximum radius, as indicated by the attribute(s), the leaf is split into two or more leaves. Additionally, if an increase in the number of leaves would cause a node to exceed the maximum number of cluster features, as also indicated by the attribute(s), the node is split into two or more child nodes. In either instance, the system(s) may update one or more (e.g., all) of the cluster features on a path of where the feature was added, which may also update at least some of the visual words associated with the vocabulary tree. Additionally, these processes may then continue to repeat such that the vocabulary tree is continuously updated to best represent the environment.

In some examples, the system(s) may further use one or more techniques to determine weights associated with at least a portion of the visual words. For instance, the system(s) may process the images (e.g., all of the images) using one or more techniques—such as a structure-from-motion (SFM) procedure (and/or any other technique)—to determine three-dimensional (3D) landmarks (e.g., all 3D landmarks) within the environment. For individual 3D landmarks (e.g., each 3D landmark), the system(s) may then determine their two-dimensional (2D) observations in the images along with their corresponding descriptors. The system(s) may then determine a weight for a visual word based at least on the number of 3D landmarks whose 2D descriptors match the visual word and the total number of 3D landmarks in the environment. In some examples, the system(s) may then use the vocabulary dictionary and/or the weights to determine global descriptors associated with the images, where the global descriptors are stored in association with the images and/or the localization map.

As described herein, the system(s) (and/or one or more other systems, such as a system of a machine) may then use the localization map to perform localization with respect to machines within the environment. For instance, the system(s) may receive image data obtained using one or more image sensors of a machine. In some examples, the image data may represent an image pair, such as a right image from a right image sensor and a left image from a left image sensor of a stereo camera (and/or any other type of image pair). The system(s) may then use the vocabulary dictionary and/or the weights to generate a global descriptor for at least one of the images—such as the left image—and use the global descriptor to identify a related map image. For instance, in some examples, the system(s) may determine correlation scores between the global descriptor of the captured image and the global descriptors of the map images and then select at least one of the map images based on the correlation scores (e.g., select the map image(s) associated with the highest correlation score(s)). Additionally, in some examples, the system(s) may use additional processing to select a final map image for performing localization, such local feature matching and/or geometry validation.

To perform localization, the system(s) may use a first image (e.g., the left image) that was used to identify the map image from the image pair, a related second image (e.g., the right image) from the image pair, and the map image. For example, the system(s) may determine a first relative pose between the first image and the map image, a second relative pose between the second image and the map image, and a third relative pose between the first image and the second image. In some examples, the system(s) determines the first relative pose using a first essential matrix obtained for the first image and the map image, the second relative pose using a second essential matrix obtained for the second image and the map image, and the third relative pose using a calibration between the image sensors. In some examples, the rotations of the first and second relative poses may be estimated, however, the translations of the first and second relative poses may be obtained up to a scale factor.

As such, the system(s) may use the relative poses to determine at least a first predicted pose between the first image and the map image and/or a second predicted pose between the second image and the map image. In some examples, the system(s) determines the predicted pose(s) based on analyzing the third relative pose with respect to a combination of the first relative pose and the second relative pose, which is described in more detail herein. For instance, since the translation scale of the third relative pose is calibrated, the calibrated translation scale may be used to estimate the translation scale factor(s) for the predicted pose(s) using simple linear fitting methods. As such, using such a process, the system(s) may determine at least a predicted pose that includes the estimated rotation (e.g., the angular change, orientation, etc.) and the estimated translation (e.g., the linear movement, displacement, etc.) between the first image and the map image. In some examples, the system(s) may then use the predicted pose along with a known pose associated with the map image to determine a localized pose associated with the machine within the environment.

However, in some examples, the system(s) may initially perform one or more optimization techniques to further refine the predicted pose(s). For instance, the system(s) may attempt to minimize the distances of points within the first and second images to epipolar lines corresponding to the points. As described in more detail herein, minimizing the distances may update the predicted pose(s)—such as the estimated rotation(s) and/or the estimated translation(s)—to determine at least a first refined pose between the first image and the map image and/or a second refined pose between the second image and the map image. The optimization procedure may only use inlier feature observations that pass the geometry verification based on the essential matrix. Optimization is often an iterative procedure, and the first step initial guess uses previously predicted pose using linear fitting methods. Additionally, the system(s) may then use a refined pose along with the known pose associated with the map image to determine the localized pose associated with the machine within the environment.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine locations of machines, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., sensor data from within the simulation. The synthetic training data (in addition to or alternatively from real-world data) may then be used or processed to perform localization.

In any example, such as where a simulation environment is used for testing, validation, training, etc., the simulation environment and/or associated training data may be rendered or otherwise generated using one or more light transport simulation algorithms-such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems-such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used to provide location inputs that may be included in a visualization or mapping of an environment to aid a remote operator in controlling—or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

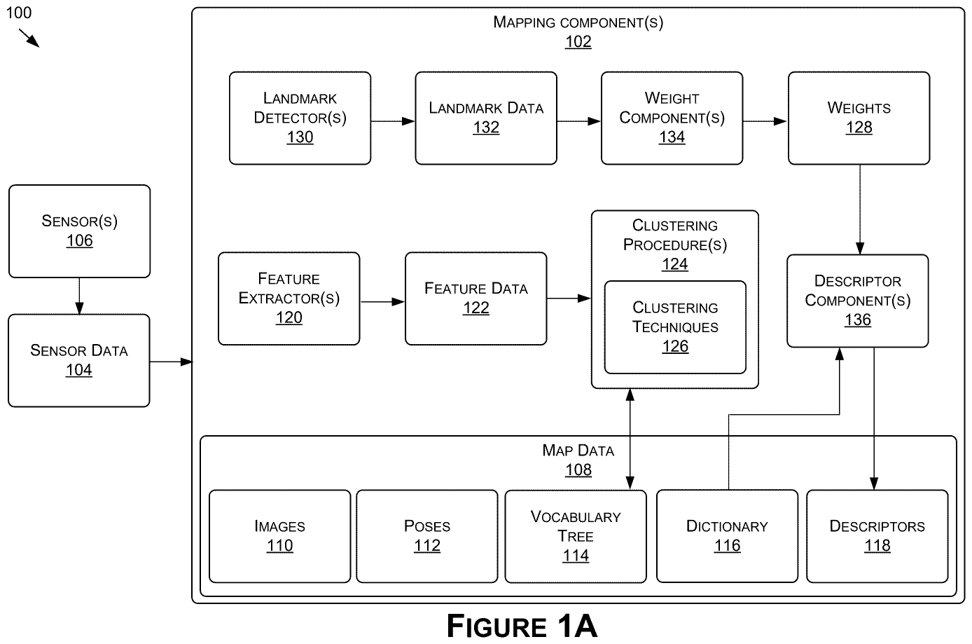

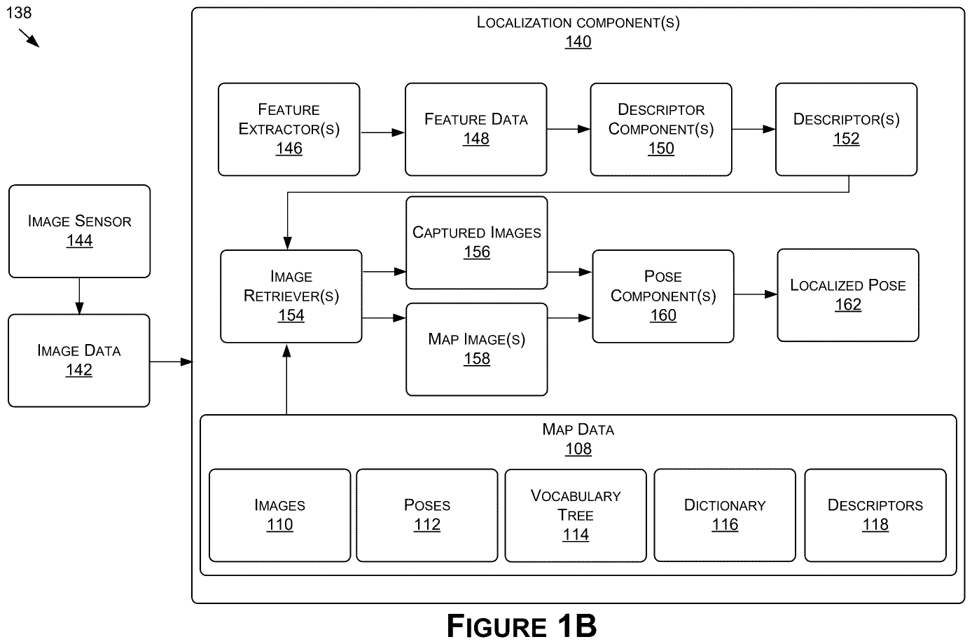

With reference to FIG. 1A, FIG. 1A illustrates an example data flow diagram for a process 100 of generating a vocabulary dictionary that is used for performing localization in an environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1200 of FIGS. 12A-12D, example computing device 1300 of FIG. 13, and/or example data center 1400 of FIG. 14.

For instance, the process 100 may include one or more mapping components 102 receiving sensor data 104 obtained using one or more sensors 106 located within an environment. As described herein, the sensor data 104 may include, but is not limited to, image data representing images of the environment, pose data representing poses of the sensor(s) 106 when generating the image data, motion data (e.g., odometry data) representing motion of the sensor(s) 106 when generating the image data, LiDAR data representing point clouds corresponding to the environment, and/or any other type of sensor data. Additionally, the environment may include an interior environment—such as a retail environment, a warehouse environment, an office environment, an educational environment, and/or any other type of interior environment—and/or the environment may include an outdoor environment. In some examples, the mapping component(s) 102 may receive an entirety of the sensor data 104 at a single instance. However, in other examples, the mapping component(s) 102 may receive portions of the sensor data 104 at different instances.

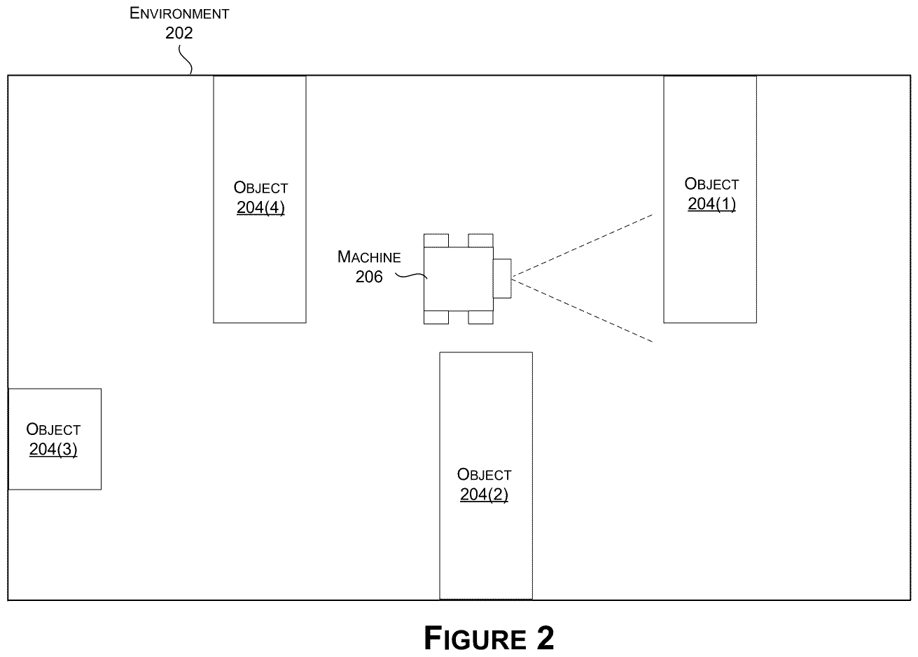

For instance, FIG. 2 illustrates an example of capturing sensor data representing an environment 202, in accordance with some embodiments of the present disclosure. In the example of FIG. 2, the environment 202 may include an interior environment—such as a retail environment, a warehouse environment, an office environment, an educational environment, and/or the like—with objects 204(1)-(4) (also referred to singularly as “object 204” or in plural as “objects 204”). As such, a machine 206 may navigate throughout the environment 202 and generate sensor data representing the environment 202. For example, the machine 206 may generate at least image data representing images of the environment 202 along with pose data representing poses of the machine 206 when generating the image data. While the example of FIG. 2 illustrates only a single machine navigating within the environment 202, in other examples, any number of machines may navigate within the environment 202 to obtain the sensor data.

Referring back to the example of FIG. 1A, the process 100 may include the mapping component(s) 102 using at least a portion of the sensor data 104 to generate and/or update a localization map of the environment, where the localization map may be represented by map data 108. As shown, the localization map may include and/or be associated with at least images 110 of the environment, poses 112 associated with the images 110, a vocabulary tree 114 that represents visual words corresponding to the environment, a vocabulary dictionary 116 associated with the environment, and/or global descriptors 118 associated with the images 110. In some examples, the mapping component(s) 102 may store all of the images 110 represented by the sensor data 104 in association with the localization map. However, in other examples, the mapping component(s) 102 may store only a portion of the images 110 represented by the sensor data 104 in association with the localization map, such as keyframes.

For instance, the process 100 may include the mapping component(s) 102 using one or more feature extractors 120 to process the image data in order to detect features within the images 110 and/or generate descriptors associated with the features, where the extracted features and/or the associated descriptors may be represented by feature data 122. As described herein, the feature extractor(s) 120 may use any technique to extract the features and/or generate the descriptors, such as SIFT, Superpoint, Harris corner detection, FAST algorithm, and/or any other type of feature extraction technique. Additionally, a descriptor associated with an extracted feature may include, but is not limited to, a vector representing a patch located around the extracted feature within an image 110. For example, the descriptors may include 128-dimensional feature vectors (and/or any other types of vectors) of the extracted features.

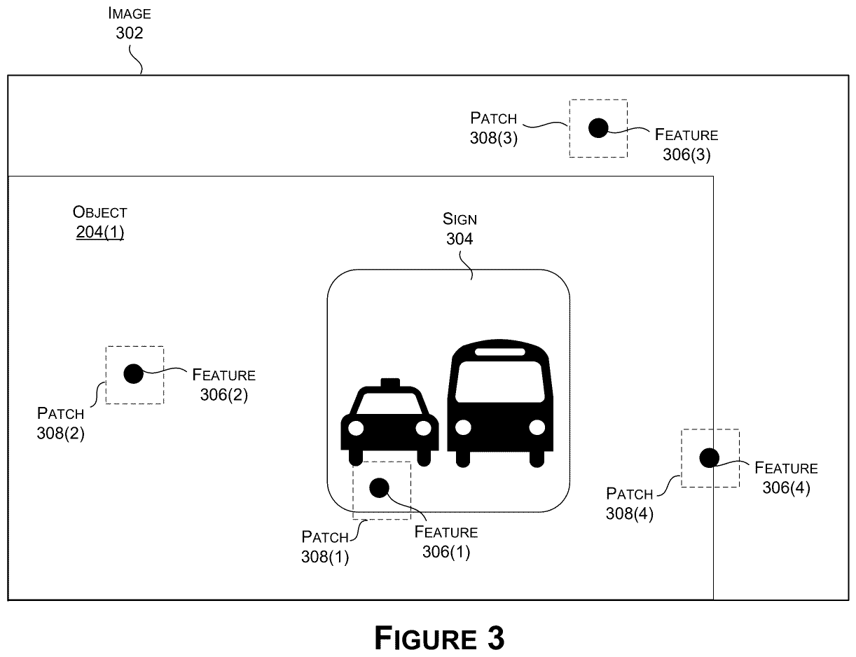

For instance, FIG. 3 illustrates an example of extracting features from an image 302, in accordance with some embodiments of the present disclosure. As shown by the example of FIG. 3, the machine 206 may have captured the image 302 of the environment 202, where the image 302 represents at least the first object 204(1) along with a sign 304 that is located on the first object 204(1). The feature extractor(s) 120 may then process the image 302 in order to extract features 306(1)-(4) (also referred to singularly as “feature 306” or in plural as “features 306”) from the image 302. Additionally, the feature extractor(s) 120 may generate descriptors associated with patches 308(1)-(4) (also referred to singularly as “patch 308” or in plural as “patches 308”) associated with the features 306. While the example of FIG. 3 illustrates the feature extractor(s) 120 as extracting four features 306 from the image 302, in other examples, the feature extractor(s) 120 may extract any number of features from images.

Referring back to the example of FIG. 1A, the process 100 may include the mapping component(s) 102 using an initial clustering procedure 124 to initially generate the vocabulary tree 114 associated with the vocabulary dictionary 116 for the environment. As shown, the initial clustering procedure 124 may use one or more clustering techniques 126 to generate the vocabulary tree 114, such as K-Means Clustering, BIRCH, and/or any other type of clustering technique. For an example, the initial clustering procedure 124 may include using K-Means Clustering to cluster the descriptors represented by the feature data 122 into cluster features in a hierarchical manner. The clustering procedure is performed into several levels. At the top level, all the descriptors are classified into predefined number of clusters. Then, at the next level, all the descriptors in each cluster will be further classified into smaller clusters, the procedure will be recursive until the vocabulary tree grows into the maximal level. At one specific level, the clustering procedure composes the following steps. The first step is to select the center for each cluster using random sampling or algorithms based on descriptor distance. The second step is to classify all the feature descriptors involved to the nearest clusters using the distance to their centers. The third step is to update the center of each cluster by averaging all the feature descriptors in the cluster. The second step and the third step will be alternatively applied recursively until the algorithm gets converged classification result. As described herein, an individual cluster feature may be associated with attributes, such as a number of data objects (e.g., features, patches, descriptors, etc.) within the cluster feature, a linear sum of the data objects in the cluster feature, and/or a squared sum of the data objects within the cluster feature. Additionally, the cluster features may be used to determine visual words associated with the vocabulary dictionary 116. For example, a visual word may be defined as a center (the centroid descriptor) of a learned cluster feature (and/or any other location within the learned cluster feature).

As such, the initial clustering procedure 124 may use the cluster features to generate the vocabulary tree 114. For instance, the internal nodes of the vocabulary tree 114 may represent one or more cluster features while the leaves of the vocabulary tree 114 may represent visual words associated with the vocabulary dictionary 116. As described herein, a user may set and/or the mapping component(s) 102 may determine one or more attributes associated with the vocabulary tree 114—such as a number of visual words, a maximum number of cluster features per node, a maximum radius of the leaves, and/or any other attribute—where the initial clustering procedure 124 (along with subsequent clustering procedures 124) uses the attributes for generating and/or updating the vocabulary tree 114.

As described herein, after initially generating the vocabulary tree 114, the process 100 may include the mapping component(s) 102 using an additional clustering procedure 124 to update the vocabulary tree 114. In some examples, the additional clustering procedure 124 may update the vocabulary tree 114 using additional images represented by the already received sensor data 104. However, in other examples, the additional clustering procedure 124 may update the vocabulary tree 114 using new images represented by new image data obtained using the sensor(s) 106. For example, based on the occurrence of one or more events—such as a period of time elapsing, at least a portion of the environment being updated, a request being received, and/or any other event—the mapping component(s) 102 may update the vocabulary tree 114 using new image data. This way, the mapping component(s) 102 ensures that the vocabulary dictionary 116 corresponding to the vocabulary tree 114 represents a most current layout of the environment.

To update the vocabulary tree 114, the feature extractor(s) 120 may again process the new images to generate the feature data 122 representing extracted features and/or descriptors associated with the extracted features. For a new feature, the additional clustering procedure 124 may include selecting a node of the vocabulary tree 114 for adding the new feature and/or the associated descriptor. For instance, in some examples, an intermediate node is selected that minimizes a distance at individual levels (e.g., each level) from the root to a leaf. However, in other examples, any other technique may be used to select a node for the new feature. The additional clustering procedure 124 may then use the attributes to determine whether to update the vocabulary tree 114 based on the addition of the new feature.

For instance, if the new feature would cause the leaf to exceed the maximum radius, where the radius is determined using at least the linear sum of the data objects and/or the squared sum of the data objects, then the leaf is split into two or more leaves. For example, the leaf may be split into two new leaves, where each new leaf includes at least a portion (e.g., half, etc.) of the data objects. Additionally, if an increase in the number of leaves would cause a node to exceed the maximum capacity number of cluster features, the node is split into two or more child nodes. For example, the node may be split into two new child nodes, where each new child node includes at least a portion (e.g., half, etc.) of the leaves. Among all the leaves involved, the two leaves which have the maximal distance are selected as the centers of the two split nodes, all the other leaves will be classified according to their distance to those two centers. The additional clustering procedure 124 may then update one or more (e.g., all) of the cluster features on a path of where the new feature was added, which may also update the visual words associated with the vocabulary tree 114. As described herein, these processes may then continue to be repeated using additional new features extracted from the new images.

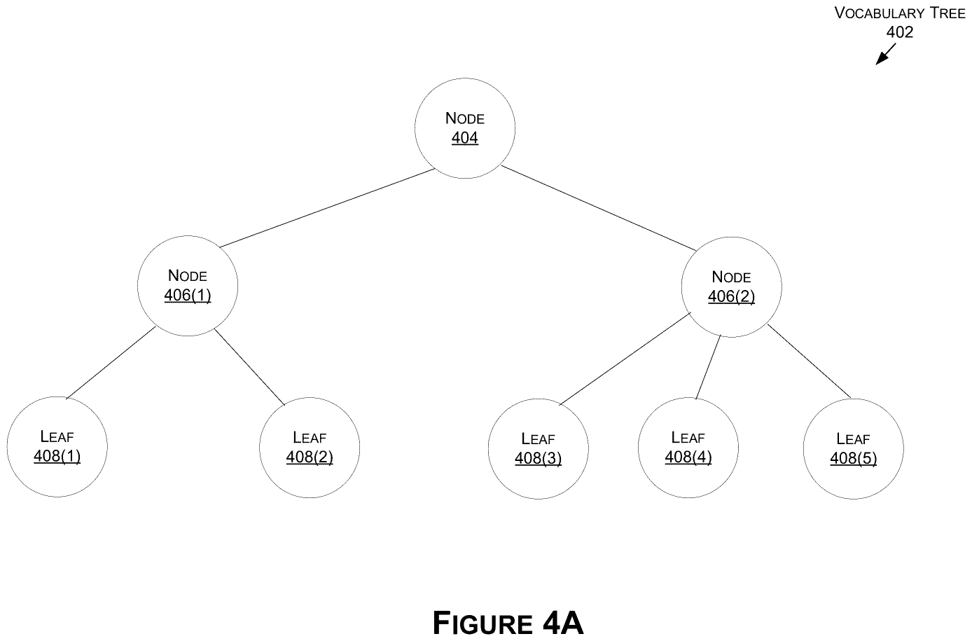

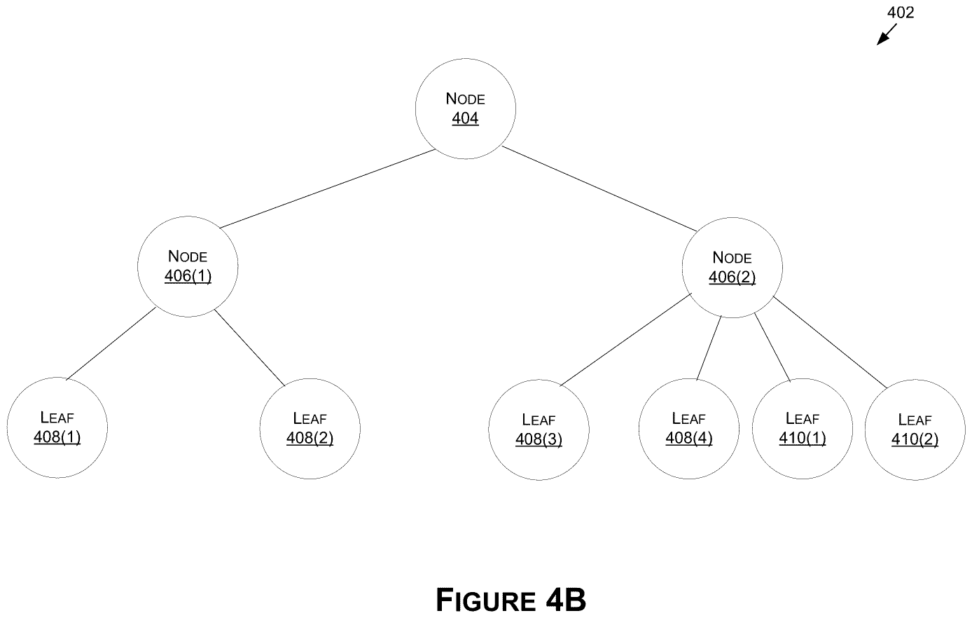

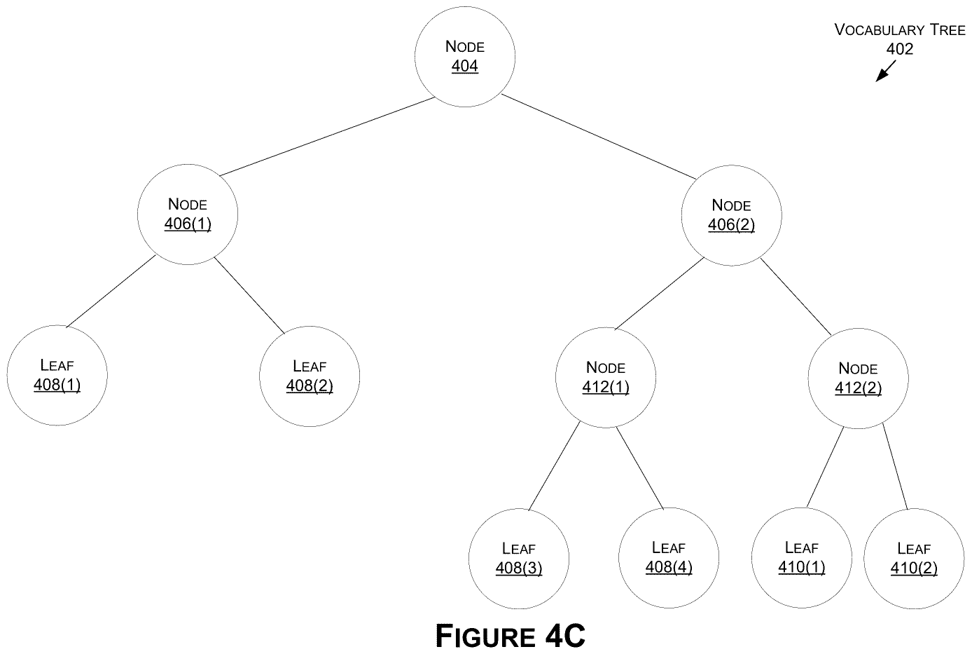

For instance, FIGS. 4A-4C illustrate an example of generating and then updating a vocabulary tree 402 (which may include, and/or be similar to, the vocabulary tree 114) associated with the environment 202, in accordance with some embodiments of the present disclosure. As shown by the example of FIG. 4A, an initial clustering procedure 124 may generate the vocabulary tree 402 to include a root node 404, intermediate nodes 406(1)-(2), and leaves 408(1)-(5). For instance, the first intermediate node 406(1) may represent a first set of cluster features, the second intermediate node 406(2) may represent a second set of cluster features, while the root node 404 represents both the first set of cluster features and the second set of cluster features. Additionally, the leaves 408(1)-(5) may represent visual words corresponding to a vocabulary dictionary associated with environment 202. For example, the first leaf 408(1) may be associated with a cluster feature, where the visual word associated with the first leaf 408(1) is determined using the cluster feature (e.g., the center of the cluster feature).

Next, and as illustrated by the example of FIG. 4B, an additional clustering procedure 124 may add a new feature to the vocabulary tree 402. For instance, the new feature may be added to the second intermediate node 406(2) based on minimizing a distance between the root node 404 and the fifth leaf 408(5). Once the new feature is added, the additional clustering procedure 124 may determine that the radius associated with the fifth leaf 408(5) exceeds the maximum radius. As such, the additional clustering procedure 124 may split the fifth leaf 408(5) into at least a first new leaf 410(1) and a second new leaf 410(2). In some examples, the first new leaf 410(1) may then be associated with a first new visual word and the second new leaf 410(2) may be associated with a second new visual word.

Next, and as illustrated by the example of FIG. 4C, the additional clustering procedure 124 may determine that, with the addition of the new leaves 410(1)-(2), the second intermediate node 406(2) exceeds the maximum capacity number of cluster features (e.g., which may be three in the examples of FIGS. 4A-4C). As such, the additional clustering procedure 124 may split the second intermediate node 406(2) into two new child nodes 412(1)-(2). As shown, the first new child node 412(1) may be associated with the leaves 408(3)-(4) and the second new child node 412(2) may be associated with the leaves 410(1)-(2). These processes may then continue to repeat as the additional clustering procedure 124 continues adding new features to the vocabulary tree 114. In some embodiments, the classification accuracy of the visual words can be further improved by applying some global clustering algorithms (e.g. the weighted K-means clustering algorithm) to all the obtained leaves from the above incremental clustering process.

Referring back to the example of FIG. 1A, in some examples, the mapping component(s) 102 may determine weights 128 associated with at least a portion of the visual words from the vocabulary tree 114. For instance, and as shown, the process 100 may include the mapping component(s) 102 using one or more landmark detectors 130 to process the images 110 (e.g., all of the images 110) using one or more techniques—such as a SFM procedure (and/or any other technique)—to determine 3D landmarks (e.g., all 3D landmarks) within the environment. For individual 3D landmark (e.g., each 3D landmark), the landmark detector(s) 130 may then determine their two-dimensional (2D) observations (e.g., features) in the images 110 along with their corresponding descriptors. As such, the process 100 may include the landmark detector(s) 130 outputting landmark data 132 representing the 3D landmarks, the 2D observations associated with the 3D landmarks within the images 110, and the descriptors associated with the 2D observations.

The process 100 may then include the mapping component(s) 102 using one or more weight components 134 that use the landmark data 132 to determine the weights 128. As described herein, the weight component(s) 134 may use one or more equations to determine the weights 128 based on the landmark data 132. For instance, in some examples, the weight component(s) 134 may determine a weight 128 for a visual word using the following equations:

$$Weight = TF \times IDF \qquad ( 1 )$$

$$IDF = - log P \qquad ( 2 )$$

$$P = \frac{( Number of 3 D landmarks who 2 D descriptors match a visual word )}{( Total number of the 3 D landmarks )} \qquad ( 3 )$$

TF means “Term Frequency”, which is the probability of the visual word in the query image. IDF means “inverse document frequency”, which is determined by the probability of the visual word in the whole map. P is the probability of the visual word in mapped environment.

By using equations (1)-(3), the weight component(s) 134 may determine the weights 128 such that visual words that are more important for performing localization include greater weights as compared to visual words that are less important for performing localization. For instance, visual words of unique features within the environment, such as signs, objects, colors, and/or the like, may include a greater weight as compared to visual words of common features within the environment, such as a plain wall or other surface.

As further illustrated in the example of FIG. 1A, in some examples, the process 100 may include using one or more descriptor components 136 to generate the global descriptors 118 associated with the images 110. As described herein, the global descriptors 118 may include vectors, also referred to as “global vectors” and/or “BOW vectors,” that represent the images 110. For instance, and as shown, the descriptor component(s) 136 may generate the global descriptors 118 using at least the vocabulary dictionary 116 associated with the environment and the weights 128 associated with the visual words from the vocabulary dictionary 116.

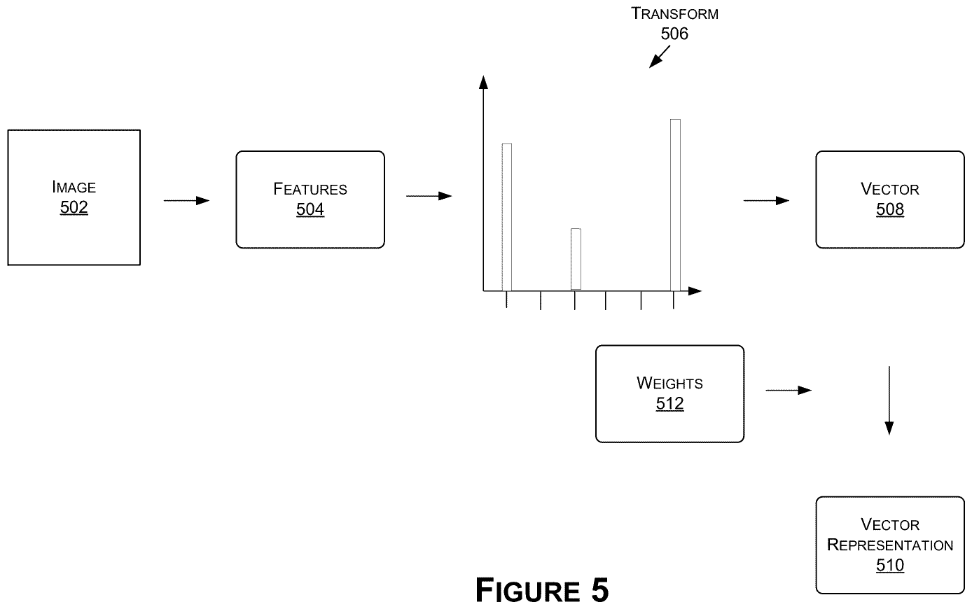

For more details, FIG. 5 illustrates an example of determining a global descriptor associated with an image 502, in accordance with some embodiments of the present disclosure. As shown, the descriptor component(s) 136 may initially process the image 502—such as by using one or more of the processes described herein (e.g., the feature extractor(s) 120)—to determine features 504 associated with the image 502. The descriptor component(s) 136 may then use the features 504 and the vocabulary dictionary (e.g., the vocabulary dictionary 116, a codebook, etc.) to transform 506 the features into visual words, where the transformation is represented by a histogram for visual purposes. For instance, the individual elements along the x-axis of the histogram correspond to visual words and the y-axis of the histogram corresponds to frequencies of the visual words within the image 502.

The descriptor component(s) 136 may then use the frequencies of the visual words to generate a vector 508 that represents the image 502. In some examples, since individual values of the vector 508 correspond to a respective visual word from the vocabulary dictionary, the vector 508 may correspond to a “sparse” vector since most of the values will be zero based on the image 502 including only a portion of the total number of visual words associated with the environment 202. As further shown, in some examples, the descriptor component(s) 136 may then generate a final vector representation 510 of the image 502 by adjusting the vector 508 using weights 512 associated with the visual words, where the final vector representation 510 corresponds to a global descriptor for the image 502.

Referring back to the example of FIG. 1A, in some examples, the mapping component(s) 102 may generate the vocabulary dictionary 116 using the vocabulary tree 114, where the vocabulary dictionary 116 includes at least one or more (e.g., all) of the visual words from the vocabulary tree 114. Additionally, in some examples, the mapping component(s) 102 may generate an index associated with the frames 110, where the index indicates relevant frame identification information for one or more (e.g., each) of the visual words from the vocabulary dictionary 116. For instance, the index may associate the visual words with the frames 110 that include features corresponding to the visual words.

Next, FIG. 1B illustrates an example data flow diagram for a process 138 of using a vocabulary dictionary and multiple images to perform localization, in accordance with some embodiments of the present disclosure. As shown, the process 138 may include one or more localization components 140 receiving image data 142 obtained using image sensors 144 of a machine located within the environment. In some examples, the image data 142 may be obtained using a stereo camera of the machine, where the image data 142 then represents a left image captured using a left image sensor 144 of the stereo camera and a right image captured using a right image sensor 144 of the stereo camera. However, in other examples, the image data 142 may represent any number of images captured using any number of image sensors 144 from any number of cameras of the machine.

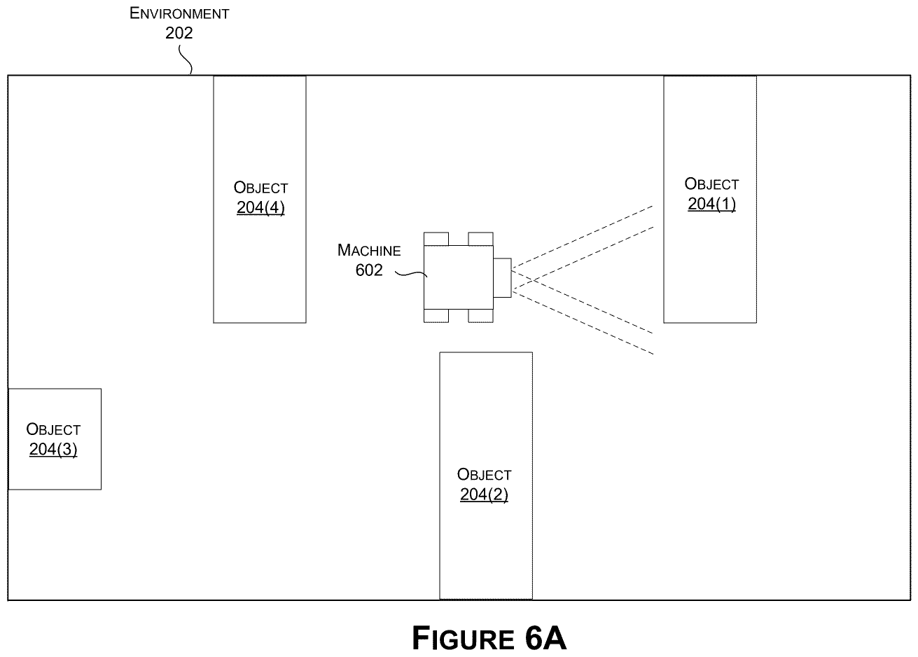

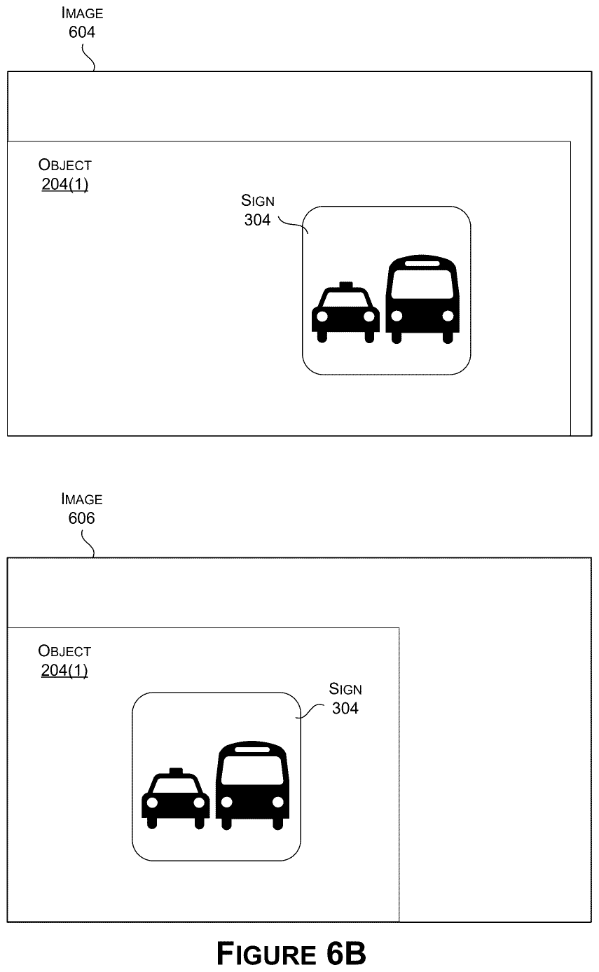

For instance, FIGS. 6A-6B illustrate an example of a machine 602 obtaining image data for performing localization within the environment 202, in accordance with some embodiments of the present disclosure. In the example of FIG. 6A, the machine 602 may be activated at and/or moved to a location within the environment 202. As such, the machine 602 may initially need to determine a localized pose within the environment 202, such as a location and/or an orientation of the machine 602 within the environment 202. To determine the localized pose, the machine 602 may use image sensors to obtain image data representing a portion of the environment 202, which is indicated by the dashed lines.

For instance, and as illustrated in the example of FIG. 6B, the machine 602 may use at least a first image sensor to capture a left image 604 of the environment and a second image sensor to capture a right image 606 of the environment. In some examples, the first image sensor and the second image sensor may be included within a stereo camera of the machine 602. As such, in some examples, the first image sensor may capture the left image 604 at approximately a same time that the second image sensor captures the right image 606. Additionally, the left image 604 may represent at least a same portion of the environment 202 as the right image 606, such as the first object 204(1) and the sign 304.

Referring back to the example of FIG. 1B, the process 138 may include the localization component(s) 140 using one or more feature extractors 146 (which, in some examples, may include the feature extractor(s) 120) to process the image data 142 in order to detect features within at least one of the images (e.g., the left image), where the extracted features are represented by feature data 148. As described herein, the feature extractor(s) 146 may use any technique to extract the features, such as SIFT, Superpoint, Harris corner detection, FAST algorithm, and/or any other type of feature extraction technique.

The process 138 may then include the localization component(s) 140 using one or more descriptor components 150 (which, in some examples, may include the descriptor component(s) 136) to process the feature data 148 and generate one or more global descriptors 152 associated with the image(s). As described herein, the descriptor component(s) 136 may perform any technique to generate the global descriptor(s) 152, such the technique described with respect to FIG. 5. For example, the descriptor component(s) 136 may generate the global descriptor(s) 152 using the extracted features from the image(s), the vocabulary dictionary 116, and/or the weights 128. In some examples, the localization component(s) 140 may perform these processes to generate a single global descriptor 152 for single image from an image pair, such as the left image. However, in other examples, the localization component(s) 140 may perform these processes to generate global descriptors 152 for both images from the image pair.

The process 138 may then include the localization component(s) 140 using one or more image retrievers 154 to identify at least one of the map images 110 that is related to at least one of the captured images. For instance, in some examples, the image retriever(s) 154 may compare the global descriptor 152 for a captured image to the global descriptors 118 for the map images 110 to determine correlation scores between the global descriptor 152 and the global descriptors 118. In some examples, the image retriever(s) 154 may use any technique to compare the global descriptor 152 to the global descriptors 118, such as by taking the inner products between the vectors, the dot products between the vectors, the Euclidean distances between the vectors, the cosine similarities between the vectors, and/or any other technique. The image retriever(s) 154 may then use the correlation scores to select one or more map images 110 that are related to the captured image. For example, the image retriever(s) 154 may select the map image(s) 110 that is associated with the highest correlation score(s).

In some examples, the image retriever(s) 154 may then perform additional processing to identify a map image from the selected map image(s) to use for localization. For instance, and for a selected map image, the image retriever(s) 154 may perform local feature mapping to associate features in the selected map image to features in the captured image. In some examples, the matching procedure is based on appearance comparisons, such as by calculating distances (e.g., the L2 distances) of corresponding descriptors of the features from the images.

The image retriever(s) 154 may then perform geometry validation where matched feature pairs within the images should pass a two-view fundamental matrix check. In some examples, feature pairs that pass the two-view fundamental matrix check may be referred as “inliers” while feature pairs that do not pass the two-view fundamental matrix check may be referred to as “outliers.” The image retriever(s) 154 may then use more than enough inliers between the captured image and the selected map image(s) to identify the map image for performing localization. For example, the image retriever(s) 154 may identify the map image that is associated with the greatest number of inliers (and/or using any other technique).

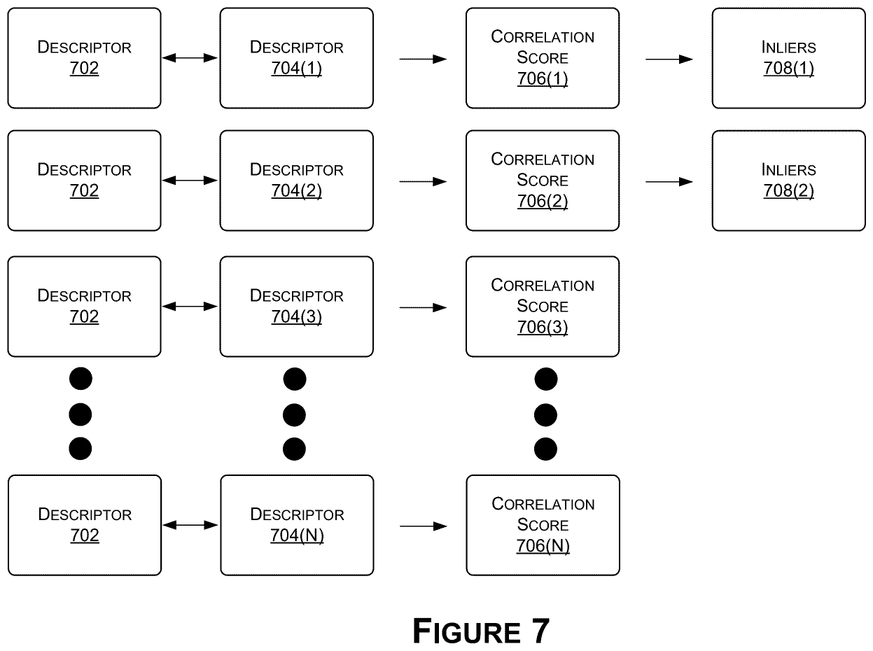

For more details, FIG. 7 illustrates an example of identifying a map image that is related to a captured image when performing localization, in accordance with some embodiments of the present disclosure. As shown, the localization component(s) 140 may initially perform one or more of the processes described herein to generate a global descriptor 702 for the left image 604 along with global descriptors 704(1)-(N) for map images associated with a localization map of the environment 202. The image retriever(s) 154 may then compare the global descriptor 702 to the global descriptors 704(1)-(N) to determine correlation scores 706(1)-(N) associated with the map images. In the example of FIG. 7, the image retriever(s) 154 may then initially select the map images associated with the global descriptors 704(1)-(2) based on the correlation scores 706(1)-(2). For example, the correlation scores 706(1)-(2) may include the highest scores and/or may satisfy (e.g., be equal to or greater than) a threshold score.

The image retriever(s) 154 may then perform local feature mapping and geometry validation to determine numbers of inliers 708(1)-(2) associated with the selected map images. Additionally, the image retriever(s) 154 may use the numbers of inliers 708(1)-(2) to identify a map image for performing localization. For example, the image retriever(s) 154 may select the map image that is associated with the greatest number of inliers, such as the map image that is associated with the first global descriptor 704(1). In the example of FIG. 7, the first global descriptor 704(1) may be associated with the image 302 of the environment 202.

Referring back to the example of FIG. 1B, the process 138 may include the image retriever(s) 154 outputting at least image data representing a pair of captured images 156 to perform localization along with one or more map images 158 identified from the map images 110. For instance, in some examples, the image retriever(s) 154 may output at least a pair of captured images 156 that includes a left captured image 156 and a right captured image 156 from a stereo camera along with one map image 158 identified using one of the captured images 156 from the pair of captured images 156. The process 138 may then include the localization component(s) 140 using one or more pose components 160 to process the image data representing the captured images 156 and the map image(s) 158 to determine a localized pose 162 of the machine within the environment.

For instance, the pose component(s) 160 may initially determine a first relative pose between a first captured image 156 and the map image 158, a second relative pose between a second captured image 156 and the map image 158, and a third relative pose between the pair of captured images 156. In some examples, the pose component(s) 160 determines the first relative pose using a first essential matrix obtained for the first captured image 156 and the map image 158, the second relative pose using a second essential matrix obtained for the second captured image 156 and the map image 158, and the third relative pose using a calibration between the image sensors 144. In some examples, the rotations of the first and second relative poses may be estimated, however, the translations of the first and second relative poses may be obtained up to a scale factor.

As such, the pose component(s) 160 may use the relative poses to determine predicted poses between the captured images 156 and the map image 158. In some examples, the pose component(s) 160 determines the predicted poses based on a comparison between the third relative pose to a combination of the first relative pose and the second relative pose, such as based on the following equation:

$${T}_{second}^{first} = {T}_{map}^{first} \cdot {T}_{second}^{map} \qquad ( 4 )$$

In equation (4),

$${T}_{map}^{first}$$

represents the first relative pose,

$${T}_{second}^{map}$$

represents the second relative pose, and

$${T}_{second}^{first}$$

represents the third relative pose. For instance, since the translation scale of the third relative pose is calibrated, the calibrated translation scale may be used to estimate the translation scale factors for the first and second relative poses. Because the equation (4) will be transformed into several linear equations, therefore the translation scale can be estimated using a simple linear fitting technique. As such, using such a process, the pose component(s) 160 may determine the predicted poses that include at least the estimated rotations (e.g., the angular changes, orientations, etc.) and the estimated translations (e.g., the linear movements, displacements, etc.) between the captured images 156 and the map image 158. In some examples, the pose component(s) 160 may then use a predicted pose along with the known pose 112 associated with the map image 158 to determine the localized pose 162 of the machine within the environment.

However, in some examples, the pose component(s) 160 may initially perform one or more optimization techniques to further refine the predicted poses between the captured images 156 and the map image 158. For instance, the pose component(s) 160 may attempt to minimize the distances of points within the captured images 156 to epipolar lines corresponding to the points. For example, the pose component(s) 160 may use the following equation:

ΣD(L,M)+D(M,R) (5)

In equation (5), D(L,M) represents the point to epipolar D(M,R) [symbol] represents the Sampson distance for the map image 1158 and the second captured image 156. In some examples, to increase the accuracy of equation (5), one or more (e.g., all) of the outliers may be removed when using equation (5). The optimization procedure is often an iterative procedure and need an initial guess for all the parameters to be estimated. The result of the previous linear fitting estimation will be applied here as the initial guess for the optimization procedure. As such, and as described herein, minimizing the distances using equation (5) may update the predicted poses—such as the estimated rotations and/or the estimated translations—to determine updated predicted poses between the captured images 156 and the map image 158. Additionally, the pose component(s) 160 may then use an updated predicted pose along with the known pose 112 associated with the map image 158 to determine the localized pose 162 of the machine within the environment.

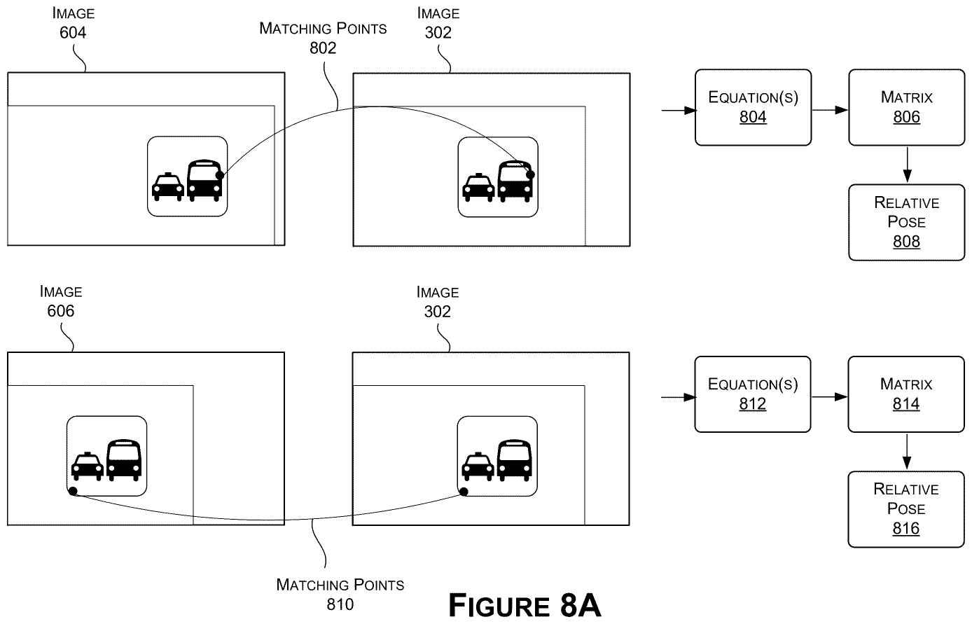

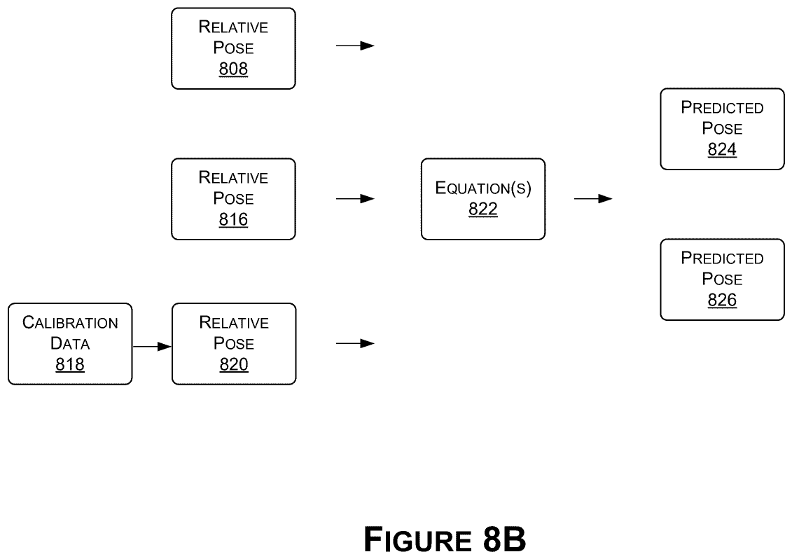

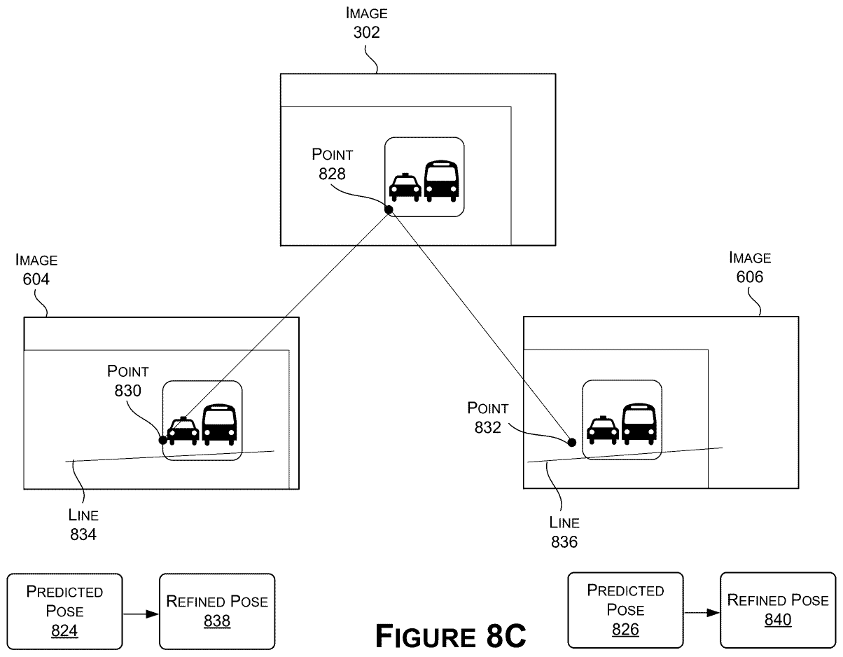

For more details about performing the localization, FIGS. 8A-8C illustrate an example of localizing the machine 602 within the environment 202 using stereo camera images, in accordance with some embodiments of the present disclosure. As shown by the example of FIG. 8A, the pose component(s) 160 may determine one or more correspondences indicating one or more matching points 802 between the left image 604 and the map image 302, although only one is labeled for clarify reasons. The pose component(s) 160 may then determine one or more equations 804—such as one or more linear equations—based on the correspondence(s) and solve the equation(s) 804 to determine a first essential matrix 806. For instance, the first essential matrix 806 may include a 3×3 matrix (and/or any other type of matrix) that describes a geometric relationship between the left image 604 and the map image 302. As such, the pose component(s) 160 may then decompose the first essential matrix 806 to determine a first relative pose 808 between the left image 604 and the map image 302. For example, the pose component(s) 160 may determine the first relative pose 808 by decomposing the first essential matrix 806.

Additionally, the pose component(s) 160 may determine one or more correspondences indicating one or more matching points 810 between the right image 606 and the map image 302, although only one is again labeled for clarify reasons. The pose component(s) 160 may then determine one or more equations 812—such as one or more linear equations—based on the correspondence(s) and solve the equation(s) 812 to determine a second essential matrix 814. For instance, the second essential matrix 814 may include a 3×3 matrix (and/or any other type of matrix) that describes a geometric relationship between the right image 606 and the map image 302. As such, the pose component(s) 160 may then decompose the second essential matrix 814 to determine a second relative pose 816 between the right image 606 and the map image 302. For example, the pose component(s) 160 may determine the second relative pose 816 by decomposing the second essential matrix 814.

As shown by the example of FIG. 8B, the pose component(s) 160 may also use calibration data 818, which represents a calibration between the image sensors used to generate the left image 604 and the right image 606, to determine a third relative pose 820 between the left image 604 and the right image 606. As described herein, in some examples, the first relative pose 808 may include an estimated rotation, an estimated direction, and a translation scale factor, the second relative pose 816 may also include an estimated rotation, an estimated direction, and a translation scale factor, while the third relative pose 820 includes a calibrated rotation, direction, and scale factor.

One or more equations 822 may then be used—such as equation (4)—to estimate the scale factor between the left image 604 and the map image 302 and the scale factor between right image 606 and the map image 302 based on the first relative pose 808, the second relative pose 816, and third relative pose 820. In some examples, the equation(s) 822 may use linear fitting and/or any other optimization technique to determine the scale factors. For instance, and as shown, the output may include at least a first predicted pose 824 between the left image 604 and the map image 302 and a second predicted pose 826 between the right image 606 and the map image 302. The first predicted pose 824 may include a predicted rotation, direction, and scale factor while the second predicted pose 826 also includes a predicted rotation, direction, and scale factor.

Next, and as illustrated in FIG. 8C, the pose component(s) 160 may refine the first predicted pose 824 and/or the second predicted pose 826. For instance, such as by using the first predicted pose 824 and the second predicted pose 826, the pose component(s) 160 may determine that a point 828 from the map image 302 corresponds to a point 830 in the left image 604 and a point 832 in the right image 606. The pose component(s) 160 may also determine that an epipolar line 834 in the left image 604 corresponds to the point 828 and an epipolar line 836 in the right image 606 corresponds to the point 828. Additionally, the pose component(s) 160 may determine a distance between the point 830 and the epipolar line 834 and a distance between the point 832 and the epipolar line 836. In some examples, the pose component(s) 160 may perform similar processes for any number of points between the map image 302, the left image 604, and the right image 606. The pose component(s) 160 may then use one or more equations—such as equation (5)—to perform optimization by minimizing the distances between the points. The results may include a first refined pose 838 between the left image 604 and the map image 302 and/or a second refined pose 840 between the right image 606 and the map image 302. As described herein, the first refined pose 838 may include a refined rotation, direction, and scale factor while the second refined pose 840 also includes a refined rotation, direction, and scale factor.

The pose component(s) 160 may then use at least the first refined pose 838 and the known pose associated with the map image 302 (e.g., the pose of the machine 206 when generating the map image 302) to determine a localized pose of the machine 602 within the environment 202. As described herein, the localized pose may include at least the location (e.g., the x-coordinate location, the y-coordinate location, and/or the z-coordinate location) and the orientation (e.g., the roll, the pitch, and/or the yaw) of the machine 602 within the environment.

Referring back to the examples of FIGS. 1A-1B, in some examples, additional processes may be performed to improve the generating of the vocabulary dictionary 116 and/or the localization of machines. For instance, features located on a ground surface may be used to generate the vocabulary dictionary 116 and/or to perform the localization. To extract the features, captured images may be transformed from perspectives of images sensors to top-down (e.g., Bird's Eye View) images associated with the environment using a matrix, such as a homography matrix. The features may then be extracted from the top-down images and transformed back to the perspectives of the image sensors using the same matrix. In some examples, these features may improve the generation of the vocabulary dictionary 116 and/or the localization since the features are often close to the image sensors and/or remain constant even when the rest of the environment may be updated.

Additionally, the processes described herein may be used to perform other types of mapping operations, such as generating and/or updating a pose graph (which may be represented by the poses 112) associated with the environment. For instance, the pose graph may include nodes representing the absolute poses 112 within the environment along with edges representing the spatial constraints between the poses 112. In some examples, an edge may include a sequential link where the pose constraint is coming from an odometry of a machine or a link may include a loop link where the pose constraint is coming from the loop detection module (e.g., performing the localization processes described herein). As such, the localization component(s) 140 may use one or more of the processes described herein to calculate the absolute poses for one or more (e.g., each) of the nodes while minimizing the relative pose constraints, such as for the sequential links or the loop links.

For instance, such as to reduce accumulated drift errors of the absolute pose of an image 110, the mapping component(s) 102 may perform an iterative strategy. For example, the mapping component(s) 102 may use the localization component(s) 140 to determine a localized pose—such as by using one or more of the processes described herein—when a new image 110 is successfully associated with a corresponding map image 110. Once that occurs, the mapping component(s) 102 may update one or more (e.g., all) of the absolute poses 112 of the images 110 involved in the loop, where this procedure may then continue for new incoming images 110. As such, by performing such processes, the mapping component(s) 102 may optimize the pose graph associated with the environment.

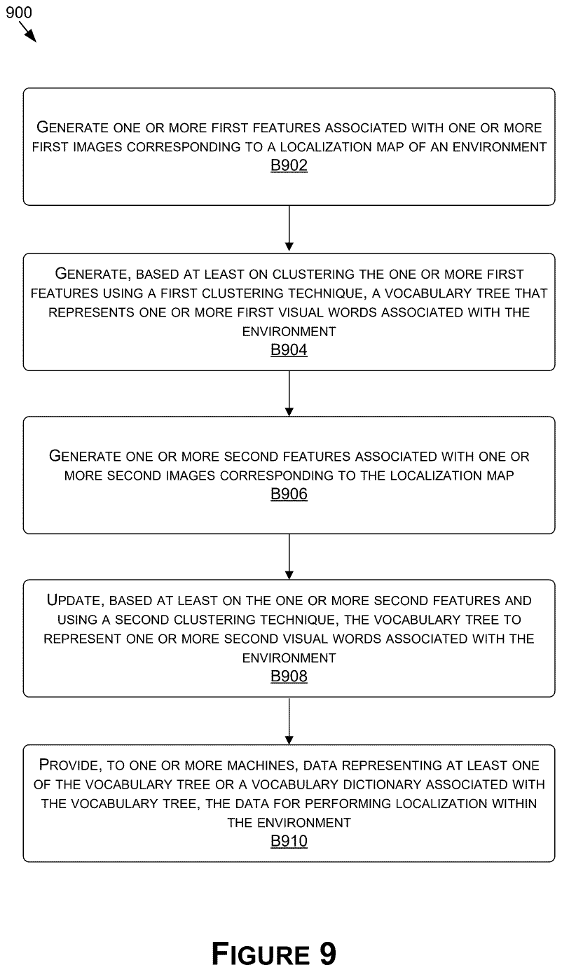

Now referring to FIGS. 9-11, each block of methods 900, 1000, and 1100, described herein, comprises a computing process that may be performed using any combination of hardware, firmware, and/or software. For instance, various functions may be carried out by a processor executing instructions stored in memory. The methods 900, 1000, and 1100 may also be embodied as computer-usable instructions stored on computer storage media. The methods 900, 1000, and 1100 may be provided by a standalone application, a service or hosted service (standalone or in combination with another hosted service), or a plug-in to another product, to name a few. In addition, these methods 900, 1000, and 1100 described, by way of example, with respect to FIGS. 1A-1B. However, these methods 900, 1000, and 1100 may additionally or alternatively be executed by any one system, or any combination of systems, including, but not limited to, those described herein.

FIG. 9 illustrates a flow diagram showing a method 900 for using multiple clustering techniques to generate and update a vocabulary dictionary, in accordance with some embodiments of the present disclosure. The method 900, at block B902, may include determining one or more first features associated with one or more first images corresponding to a localization map of an environment. For instance, the feature extractor(s) 120 may process the sensor data 104 representing at least the first image(s) 110 to generate the first feature(s) associated with the first image(s) 110. As described herein, in some examples, the feature extractor(s) 120 may further generate the first descriptor(s) associated with the first feature(s), such as one or more vectors that represent the first feature(s).

The method 900, at block B904, may include generating, based at least on clustering the one or more first features using a first clustering technique, a vocabulary tree that represents one or more first visual words associated with the environment. For instance, the mapping component(s) 102 may perform a first clustering procedure 124 that includes using at least the first clustering technique—such as K-Means Clustering (and/or any other technique)—to cluster the first feature(s) and generate the vocabulary tree 114. As described herein, the vocabulary tree 114 may represent one or more first cluster features, where the first cluster feature(s) is then used to determine the first visual word(s).

The method 900, at block B906, may include determining one or more second features associated with the one or more second images corresponding to the localization map. For instance, the feature extractor(s) 120 may process the sensor data 104 representing at least the second image(s) 110 to generate the second feature(s) associated with the second image(s) 110. As described herein, in some examples, the feature extractor(s) 120 may further generate the second descriptor(s) associated with the second feature(s), such as one or more vectors that represent the second feature(s). In some examples, the second image(s) may represent one or more similar portions of the environment as the first image(s), such as after updating the portion(s). However, in some examples, the second image(s) may represent one or more different portions of the environment as compared to the first image(s).

The method 900, at block B908, may include updating, based at least on the one or more second features and using a second clustering technique, the vocabulary tree to represent one or more second visual words associated with the environment. For instance, the mapping component(s) 102 may perform a second clustering procedure 124 that includes using at least the second clustering technique—such as BIRCH (and/or any other technique)—to cluster the second feature(s) and update the vocabulary tree 114. As described herein, updating the clustering tree 114 may include adding the second feature(s) to one or more nodes, splitting one or more leaves, and/or splitting one or more nodes. Additionally, after the updating, the vocabulary tree 114 may represent one or more second cluster features, where the second cluster feature(s) is then used to determine the second visual word(s).

The method 900, at block B910, may include providing, to one or more machines, data representing at least one of the vocabulary tree or a vocabulary dictionary associated with the vocabulary tree, the data for performing localization within the environment. For instance, the mapping component(s) 102 may provide the map data 108 to the machine(s) for performing localization within the environment.

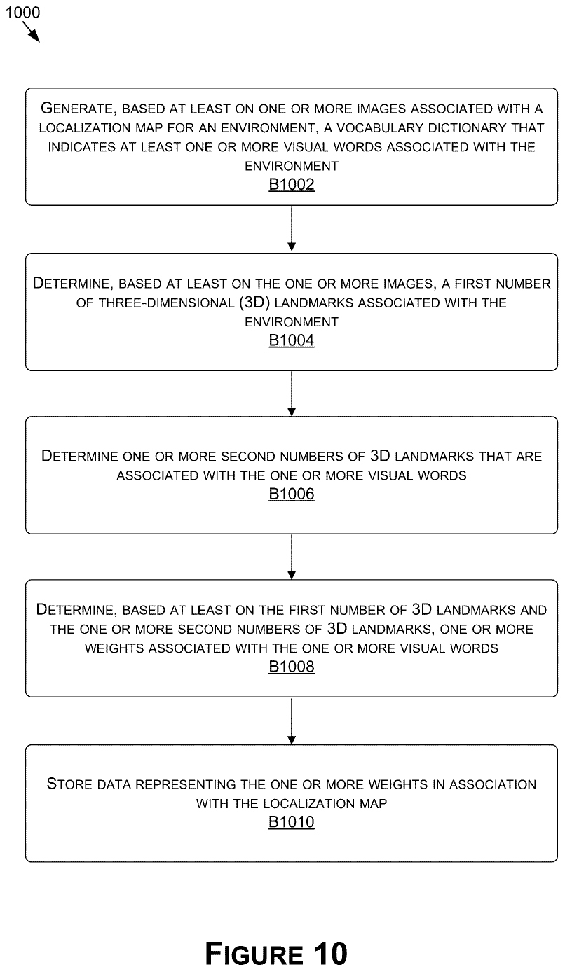

FIG. 10 illustrates a flow diagram showing a method 1000 for determining weights associated with visual words from a vocabulary dictionary, in accordance with some embodiments of the present disclosure. The method 1000, at block B1002, may include generating, based at least on one or more images associated with a localization map for an environment, a vocabulary dictionary that indicates at least one or more visual words associated with the environment. For instance, the mapping component(s) 102 may process the image(s) 110—such as by performing one or more of the processes described herein—to generate the vocabulary dictionary 116 associated with the environment. As described herein, the vocabulary dictionary 116 may indicate at least the visual word(s) associated with the environment.

The method 1000, at block B1004, may include determining, based at least on the one or more images, a first number of three-dimensional (3D) landmarks associated with the environment. For instance, the landmark detector(s) 130 may process the image(s) 110 to determine the first number of 3D landmarks within the environment. As described herein, the landmark detector(s) 130 may perform any technique to detect the 3D landmarks, such as SFM (and/or any other technique).

The method 1000, at bock B1006, may include determining one or more second numbers of 3D landmarks that are associated with the one or more visual words. For instance, the landmark detector(s) 130 may determine the second number(s) of 3D landmarks that are associated with the visual word(s). In some examples, for a visual word, the landmark detector(s) 130 may determine the number of 3D landmarks whose 2D descriptors match the visual word.

The method 1000, at block B1008, may include determining, based at least on the first number of 3D landmarks and the one or more second numbers of 3D landmarks associated with the one or more visual words, one or more weights associated with the one or more visual words. For instance, the weight component(s) 134 may use the first number of 3D landmarks and the second number(s) of 3D landmarks that match the visual words to determine the weight(s) 128 associated with the visual word(s). As described herein, by performing such processes, the visual word(s) that is more important for performing localization includes greater weight as compared to the visual word(s) that are less important for performing localization.

The method 1000, at block B1010, may include storing data representing the one or more weights in association with the localization map. For instance, the mapping component(s) 102 may store the data representing the weight(s) 128 in association with the map data 108. Additionally, in some examples, the descriptor component(s) 136 may use the vocabulary dictionary 116 and the weight(s) 128 to determine the global descriptor(s) 118 associated with the visual word(s). The mapping component(s) 102 may then further store the global descriptor(s) 118 in association with the map data 108.

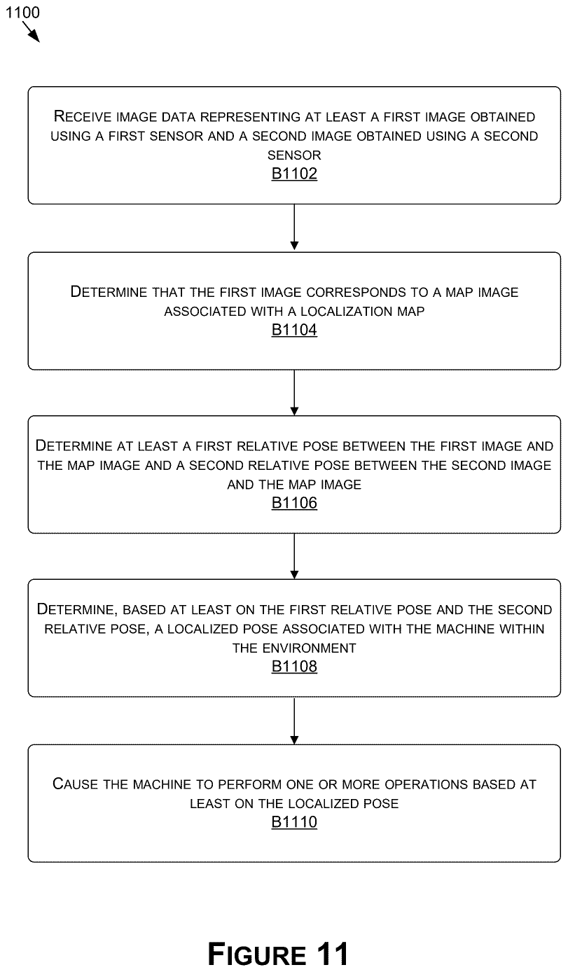

FIG. 11 illustrates a flow diagram showing a method 1100 for using a pair of images to localize a machine within an environment, in accordance with some embodiments of the present disclosure. The method 1100, at block B1102, may include receiving image data representing at least a first image obtained using a first sensor of a second image obtained using a second sensor of a machine. For instance, the localization component(s) 140 may receive the image data 142 that represents the first image 156 (e.g., the left image) obtained using the first image sensor 144 and the second image 156 (e.g., the right image) obtained using the second image sensor 144. As described herein, in some examples, the image sensors 144 may be associated with a same camera, such as a stereo camera (and/or any other type of camera).

The method 1100, at block B1104, may include determining that the first image corresponds to a map image associated with a localization map of an environment. For instance, the image retriever(s) 154 may determine that the first image 156 corresponds to the map image 158 from the localization map. In some examples, the image retriever(s) 154 may determine that the first image 156 corresponds to the map image 158 using the global descriptor 152 associated with the first image 156 and the global descriptor 118 associated with the map image 158. In some examples, the image retriever(s) 154 may use additional techniques to determine that the first image 156 corresponds to the map image 158, such as local feature matching and/or geometry validation.

The method 1100, at block B1106, may include determining at least a first relative pose between the first image and the map image and a second relative pose between the second image and the map image. For instance, the pose component(s) 160 may determine the first relative pose between the first image 156 and the map image 158 and the second relative pose between the second image 156 and the map image 158. In some examples, the pose component(s) 160 may further determine a third relative pose between the first image 156 and the second image 156, such as based on calibration data associated with the image sensors 144.

The method 1100, at block B1108, may include determining, based at least on the first relative pose and the second relative pose, a localized pose of the machine within the environment. For instance, the pose component(s) 160 may determine the localized pose 162 using at least the relative poses. In some examples, to determine the localized pose, the pose component(s) 160 may initially determine a predicted pose between the first image 156 and the map image 158 using the relative poses. The pose component(s) 160 may then determine the localized pose 162 using the predicted pose and a known pose 112 associated with the map image 158.

The method 1100, at block B1110, may include causing the machine to perform one or more operations based at least on the localized pose. For instance, the machine may determine the operation(s) to perform based at least on the localized pose 162, such as to navigate within the environment without colliding with other objects. The machine may then perform the operation(s) within the environment.

### Example Autonomous or Semi-Autonomous Machine

FIG. 12A is an example of sensor locations having corresponding fields of view or sensory fields for an autonomous or semi-autonomous vehicle 1200a, an autonomous mobile robot (AMR) 1200b, and a humanoid robot 1200c, in accordance with some embodiments of the present disclosure. Although three types of machines 1200 are illustrated, this is not intended to be limiting, and the machine(s) 1200 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1200a, AMR 1200b, humanoid robot 1200c, and/or other machine types may be referred to herein collectively as machine 1200, in some instances.

With respect to vehicles 1200A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1200 may be capable of functionality in accordance with one or more of Level 3-Level 5 of the autonomous driving levels. The machine 1200 may be capable of functionality in accordance with one or more of Level 1-Level 5 of the autonomous driving levels. For example, the machine 1200 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1200 or other machine, such as being fully autonomous, being highly autonomous, being conditionally autonomous, being partially autonomous, providing assistive autonomy, being semi-autonomous, being primarily autonomous, or other designation.

With respect to FIG. 12A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1268D, a 180 degree field of view of a wide-view camera 1270, a 360 degree sensory field of a LiDAR sensor 1264, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1200a, AMR 1200b, and/or humanoid robot 1200c, etc. For example, with respect to the vehicle 1200a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1200b and/or humanoid robot 1200c, the shape, size, purpose, implementation, model, etc. may dictate the number and types of sensors used.

As illustrated in FIG. 1A, the autonomous or semi-autonomous vehicle 1200A, the AMR 1200B, and the humanoid robot 1200C may include different sensor types, number, and locations. For a non-limiting example, the vehicle 1200A may include twelve cameras 1264, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 1264 may use, in embodiments, a gigabit multimedia serial link (GMSL) interface—such as GMSL2—as input/output (I/O).

In some embodiments, although not illustrated in FIG. 12A, the vehicle 1200A may include an in-cabin occupant and/or driver monitoring system, that may include various different sensors. For example, the in-cabin sensors may include various cameras 1268, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 1268, the internal camera(s) 1268 may, in embodiments, use a GMSL (such as GMSL2) interface for I/O.

As another non-limiting example, the vehicle 1200A may further include nine RADAR sensors 1260. For example, the vehicle 1200A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 1260 may use, in embodiments, an Ethernet interface as I/O.

The vehicle(s) 1200A may further include, as a non-limiting example, twelve ultrasonic sensors 1262. As illustrated in FIG. 12A, the ultrasonic sensors may be positioned along the front and rear bumpers of the vehicle 1200A, and along the side of the vehicle 1200A, and may be used to detect objects (static and dynamic) in close proximity to the vehicle 1200A. In some embodiments, the ultrasonic sensor(s) 1262 may use a DS13 interface as I/O.

The vehicle(s) 1200A may further include, as a non-limiting example, a LiDAR sensor 1264, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1264 may include a 360 degree horizontal FOV or sensory field (such as in a spinning LiDAR sensor) and a 90 degree vertical FOV or sensory field. In some embodiment, the LiDAR sensor(s) 1264 may use an Ethernet interface as I/O.

The autonomous mobile robot (AMR) 1200B may include, as a non-limiting example, three LiDAR sensors 1264. For example, the top-most illustrated LiDAR sensor 1264 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1200B may further include, as a non-limiting embodiment, eight cameras 1268, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree+−3 degree FOV), a rear fisheye camera (e.g., 202 degree+−3 degree FOV), a left fisheye camera (e.g., 202 degree+−3 degree FOV), and a right fisheye camera (e.g., 202 degree+−3 degree FOV).

The AMR 1200B may further include a charging port, charging port contacts, a status indicator light, one or more (e.g., four) RGB LEDs, one or more IMU sensors 1266, a magnetometer, and a barometer. The AMR 1200B is capable of high-precision time synchronization between sensors using hardware time stamping, and PTP over Ethernet with less than 10 microseconds for sensor acquisition time. The AMR 1200B provides simultaneous camera capture across all cameras 1268 within 100 microseconds from a single hardware trigger, in embodiments, and can write to disk at 4 GB/second for sensor capture to bag writing (e.g., writing to ROSbags for the robot operation system (ROS)). As such, the AMR 1200B is capable of running the ROS (such as NVIDIA's Isaac ROS), can be teleoperated (as described herein), can map an environment, and can navigate within an environment using visual cameras 1268, LiDARs 1264, and/or other sensor types or modalities.

The humanoid robot 1200C may include, as a non-limiting example, one LiDAR sensor 1264. For example, the LiDAR sensor 1264 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1200C may further include, as a non-limiting embodiment, four cameras 1268, such as a front stereo camera (e.g., 120 degree FOV), a rear stereo camera (e.g., 120 degree FOV), a front fisheye camera (e.g., 202 degree+−3 degree FOV), and a rear fisheye camera (e.g., 202 degree+−3 degree FOV).

The humanoid robot 1200C may further include, as a non-limiting embodiment, four ultrasonic sensors 1262, such as a left arm ultrasonic sensor, a right arm ultrasonic sensor, a left leg ultrasonic sensor, and right leg ultrasonic sensor.

The humanoid robot 1200C may further include any number of actuators—such as to allow control and maneuverability of joints. For example, the humanoid robot 1200C may include actuators that allow for various degrees of freedom (DoF) depending on the design. In a non-limiting embodiment, the humanoid robot 1200C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1200C may include position and orientation sensors, such as encoders, gyroscopes, and the like, to determine the position of the robot 1200C in space, allowing for location determination and movement tracking. The humanoid robot 1200C may include force and pressure sensors, in embodiments, to detect environment interactions, allowing the robot 1200C to grasp objects with the right force and to avoid obstacles along the way. The perception sensors (e.g., cameras, LiDARs, RADARs, ultrasonic, SONAR, etc.) may be used along with tactile sensors to allow the robot 1200C to perceive objects, shapes, and textures, and to understand when touch is initiated and stopped (along with force sensors that regulate the force used during touch). As a non-limiting example, the humanoid robot 1200C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 1200C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1200C may use onboard sensors, microphones, and speakers to understanding speech, audio and visual cues, etc., while also being able to communicate back to the environment.

With reference to cameras 1268 of the machine(s) 1200, the camera types for the cameras 1268 may include, but are not limited to, digital cameras that may be adapted for use with the components and/or systems of the machine 1200. For a vehicle 1200a implementation, the camera(s) 1268 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1200 (e.g., front-facing cameras) may be used for surround view, to help identify forward facing paths and obstacles, as well aid in, with the help of one or more controllers 1236 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1268B that may be used to perceive objects coming into view from the periphery (e.g., pedestrians, warehouse vehicles, other robots, crossing traffic, or bicycles). In addition, any number of long-range camera(s) 1268E (e.g., a long-view stereo camera pair) may be used for depth-based object detection, especially for objects for which a neural network has not yet been trained. The long-range camera(s) 1268E may also be used for object detection and classification, as well as basic object tracking.

Any number of stereo cameras 1268A may also be included in a front-facing and/or other (e.g., rear-facing) configuration. In at least one embodiment, one or more of stereo camera(s) 1268A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1200 environment, including a distance estimate for points in the image (e.g., a disparity or depth image). An alternative stereo camera(s) 1268A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1268A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1200 (e.g., side-view cameras) may be used, for example, for surround view, providing information used to create and update the occupancy grid, as well as to generate side impact collision warnings and/or to indicate to an AMR 1200B or humanoid robot 1200C, for example, that there are objects, features, and/or persons present to the side. For example, surround camera(s) 1268D may be positioned on the machine 1200. The surround camera(s) 1268D may include wide-view camera(s) 1268B, fisheye camera(s), 360 degree camera(s), and/or the like. For example, four fisheye cameras may be positioned on the machine's 1200 front, rear, and sides. In an alternative arrangement, the machine 1200 may use three surround camera(s) 1268D (e.g., left, right, and rear), and may leverage one or more other camera(s) (e.g., a forward-facing camera) as a fourth surround view camera.

Cameras 1268 with a field of view that include portions of the environment to the rear of the machine 1200 (e.g., rear-view cameras) may be used for gaining an understanding of objects, features, persons, and/or other information to the rear of the machine 1200, such as for park assistance, surround view, rear collision warnings, planning, control, and navigation determinations, and/or creating and updating an occupancy grid, BEV image representing the environment, height map, etc. A wide variety of cameras 1268 may be used including, but not limited to, cameras 1268 that are also suitable as a front-facing camera(s) (e.g., long-range and/or mid-range camera(s) 1268E, stereo camera(s) 1268A), infrared camera(s) 1268C, etc.), rear-facing camera(s), side-facing camera(s), downward facing camera(s), upward facing camera(s), and/or the like, as described herein.

Similarly, for LiDAR sensors 1264, RADAR sensors 1260, ultrasonic sensors 1262, and/or other sensor modalities or types, the location and placement of the sensors, and their corresponding fields of view or sensory fields may be determined based on the use case, implementation, or design of the particular machine 1200.

For example, the machine(s) 1200 include RADAR sensor(s) 1260 that may be used by the machine 1200 for long-range object detection, even in darkness and/or severe weather conditions. RADAR functional safety levels may be ASIL B, in embodiments. The RADAR sensor(s) 1260 may use the CAN and/or the bus 1202 (e.g., to transmit data generated by the RADAR sensor(s) 1260) for control and to access object tracking data, with access to Ethernet to access raw data in some examples. A wide variety of RADAR sensor types may be used. For example, and without limitation, the RADAR sensor(s) 1260 may be suitable for front, rear, and side RADAR use. In some example, Pulse Doppler RADAR sensor(s) are used.

The RADAR sensor(s) 1260 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 1260 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1200 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1260 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1200 (e.g., vehicle, robot, etc.). As such, short-range RADAR systems may be used in an ADAS system for blind spot detection and/or lane change assist.

The machine 1200 may further include ultrasonic sensor(s) 1262. The ultrasonic sensor(s) 1262, which may be positioned at the front, back, and/or the sides of the machine 1200, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1200. A wide variety of ultrasonic sensor(s) 1262 may be used, and different ultrasonic sensor(s) 1262 may be used for different ranges of detection (e.g., 2.5 m, 4 m). The ultrasonic sensor(s) 1262 may operate at functional safety levels of ASIL B, as an example.

The machine 1200 may include LiDAR sensor(s) 1264. The LiDAR sensor(s) 1264 may be used for object and feature detection, pedestrian and other robot detection, emergency braking, collision avoidance, simultaneous localization and mapping (SLAM), free-space detection, and/or other functions. The LiDAR sensor(s) 1264 may be functional safety level ASIL B, in embodiments. In some examples, the machine 1200 may include multiple LiDAR sensors 1264 (e.g., two, four, six, etc.) that may use Ethernet (e.g., to provide data to a Gigabit Ethernet switch).

In some examples, the LiDAR sensor(s) 1264 may be capable of providing a list of objects and their distances for a 360-degree field of view. Commercially available LiDAR sensor(s) 1264 may have an advertised range of approximately 1200 m, with an accuracy of 2 cm-3 cm, and with support for a 1200 Mbps Ethernet connection, for example. In some examples, one or more non-protruding LiDAR sensors 1264 may be used. In such examples, the LiDAR sensor(s) 1264 may be implemented as a small device that may be embedded into the front, rear, sides, top, and/or corners of the machine 1200. The LiDAR sensor(s) 1264, in such examples, may provide up to a 120-degree horizontal and 35-degree vertical field-of-view, with a 200 m range even for low-reflectivity objects. Front-mounted LiDAR sensor(s) 1264 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1200. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1264 may be less susceptible to motion blur, vibration, and/or shock.

FIG. 12B is an illustration of sensor and component locations of an example autonomous or semi-autonomous vehicle 1200A (alternatively referred to herein as “vehicle 1200,” “ego-vehicle 1200,” “ego-machine 1200,” or “machine 1200,”), in accordance with some embodiments of the present disclosure. Although the vehicle 1200A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 12C is a block diagram of an example system architecture for a machine 1200, such as autonomous or semi-autonomous vehicle 1200A, autonomous mobile robot (AMR) 1200B, humanoid robot 1200C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1200 of FIGS. 12A-12E, example computing ecosystem 1300 of FIG. 13, example generative language model system 1400 of FIG. 14, and/or example computing device 1500 of FIG. 15.

Each of the components, features, and systems of the machine 1200 in FIG. 12C are illustrated as being connected via bus 1202 (alternatively referred to as a “machine communications network 1202,” or just “communications network 1202”). The bus 1202 may include a Controller Area Network (CAN) data interface (alternatively referred to herein as a “CAN bus”). A CAN may be a network inside the machine 1200 used to aid in control of various features and functionality of the machine 1200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1202 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1202, this is not intended to be limiting. For example, there may be any number of busses 1202, which may include one or more CAN busses, one or more FlexRay busses, one or more Ethernet busses, and/or one or more other types of busses using a different protocol. In some examples, two or more busses 1202 may be used to perform different functions, and/or may be used for redundancy. For example, a first bus 1202 may be used for collision avoidance functionality and a second bus 1202 may be used for actuation control. In any example, each bus 1202 may communicate with any of the components of the machine 1200, and two or more busses 1202 may communicate with the same components. In some examples, each SoC 1204, each controller 1236, and/or each computer or compute engine within the machine 1200 may have access to the same input data (e.g., inputs from sensors of the machine 1200), and may be connected to a common bus, such as a CAN bus.

The machine 1200 may include components such as a chassis, a vehicle body, wheels (e.g., 2, 4, 6, 8, 18, etc.), tires, axles, batteries, side-view mirrors, and/or other components of a vehicle or machine. The machine 1200 may include a propulsion system 1250, such as an internal combustion engine, hybrid electric power plant, an all-electric engine, a hydrogen-fueled engine, and/or another propulsion system type. The propulsion system 1250 may be connected to a drive train of the machine 1200, which may include a transmission, to enable the propulsion of the machine 1200. The propulsion system 1250 may be controlled in response to receiving signals from the throttle/accelerator 1252.

A steering system 1254, which may include a steering wheel and/or other steering device (e.g., remote steering and/or local steering), may be used to steer the machine 1200 (e.g., along a desired path or route) when the propulsion system 1250 is operating (e.g., when the vehicle is in motion). The steering system 1254 may receive signals from a steering actuator 1256. In some embodiments, a steering wheel or other steering mechanism may not be included, such as for a machine 1200 capable of full automation (e.g., Level 5) functionality.

The brake sensor system 1246 may be used to operate the vehicle brakes in response to receiving signals from the brake actuators 1248 and/or brake sensors.

The machine 1200 may include one or more controller(s) 1236, such as those described herein with respect to FIG. 12A. The controller(s) 1236 may be used for a variety of functions, and may be coupled to any of the various other components and systems of the machine 1200. For example, the controllers 1236 may be used for control of the machine 1200, artificial intelligence executing on the machine 1200, infotainment for the machine 1200, and/or the like. For example, one controller 1236 may be used for some or all of the functionality, or different controllers 1236 may be used for different functionalities—e.g., to ensure availability and a safety separation between various controllers for different tasks. For example, the controller(s) 1236 may use plans computed by the system—e.g., paths or trajectories for vehicles 1200A or AMRs 1200B, or movements, components trajectories, movement locations or displacements, etc. for joints or components (e.g., of manipulators, end effectors, limbs, hands, fingers, legs, feet, etc.), of a humanoid robot 1200C—to control the machine(s) 1200 in the environment. In some instances, the controller(s) 1236 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1200C, for example, the controller(s) 1236 may act as the brain, responsible for analyzing sensor data, making decisions, and sending commands to the actuators. The controller(s) 1236 may include a low-level controller that handles basic motor control, ensuring accurate and precise movements of individual joints and actuators. The controller(s) 1236 may include a high-level controller to coordinate multiple actuators and sensors, planning complex motions and adapting to changing environments.

The controller(s) 1236 may include an artificial intelligence controller, in embodiments, that may use AI algorithms (e.g., DNNs, MLMs, etc.) to learn, make decisions, and autonomously perform tasks for the machine 1200. In some embodiments, the controller(s) 1236 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1236 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1236, which may include one or more systems on chip (SoCs) 1204 (FIGS. 12C and 12D), CPUs, GPU(s), accelerator(s), etc., may provide signals (e.g., representative of commands or messages) to one or more components and/or systems of the machine 1200. Although the controller(s) 1236 is listed separately from the SoC(s) 1204, this is not intended to be limiting, and in some embodiments one or more components of the SoC(s) 1204 may perform the operations of the controller(s) 1236. For example, the controller(s) may send signals to operate the machine brakes via one or more brake actuators 1248, to operate the steering system 1254 via one or more steering actuators 1256, to operate the propulsion system 1250 via one or more throttle/accelerators 1252, etc. The controller(s) 1236 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1200. The controller(s) 1236 may include a first controller 1236 for autonomous control and navigation functions, a second controller 1236 for functional safety functions, a third controller 1236 for artificial intelligence functionality (e.g., computer vision), a fourth controller 1236 for infotainment functionality, a fifth controller 1236 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1236 may handle two or more of the above functionalities, two or more controllers 1236 may handle a single functionality, and/or any combination thereof.

The controller(s) 1236 may provide the signals for controlling one or more components and/or systems of the machine 1200 in response to sensor data received from one or more sensors (e.g., sensor inputs). The sensor data may be received from, for example and without limitation, global navigation satellite systems (“GNSS”) sensor(s) 1258 (e.g., Global Positioning System sensor(s)), RADAR sensor(s) 1260, ultrasonic sensor(s) 1262, LiDAR sensor(s) 1264, inertial measurement unit (IMU) sensor(s) 1266 (e.g., accelerometer(s), gyroscope(s), magnetic compass(es), magnetometer(s), etc.), microphone(s) 1296, camera(s) 1268 (e.g., stereo camera(s) 1268A, wide-view camera(s) 1268B (e.g., fisheye cameras), infrared camera(s) 1268C, surround camera(s) 1268D (e.g., 360 degree cameras), long-range and/or mid-range camera(s) 1268E, and/or other camera types), speed sensor(s) 1244 (e.g., for measuring the speed of the machine 1200), vibration sensor(s) 1242, steering sensor(s) 1240, brake sensor(s) (e.g., as part of the brake sensor system 1246), actuators, and/or other sensor types.

One or more of the controller(s) 1236 may receive inputs (e.g., represented by input data) from an instrument cluster 1232 of the machine 1200 and provide outputs (e.g., represented by output data, display data, etc.) via a human-machine interface (HMI) display 1234 (e.g., screen, heads-up display, mirror display, facial display, robotic display, etc.), an audible annunciator, a loudspeaker, a speaker, and/or via other components of the machine 1200. The outputs may include information such as machine velocity, speed, time, map data corresponding to a map(s) 1222 of FIG. 12C (e.g., from a navigation map, a Standard Definition (SD) map, a High Definition (“HD”) map, etc.), location data (e.g., the machine's 1200 location, such as on a map 1222), direction, location of other vehicles (e.g., an occupancy map, height map, bird's eye view (BEV) image, grid, etc.), information about objects and status of objects as perceived by the system, system status information, etc. For example, the HMI display(s) 1234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1200 may include one or more systems on a chip (SoCs) 1204 (described in more detail in FIG. 12D). The SoC(s) 1204 may include CPU(s) 1206, GPU(s) 1208, processor(s) 1210, cache(s) 1212, accelerator(s) 1214, data store(s) 1216, and/or other components and features. The SoC(s) 1204 may be used to process and provide data for various operations, such as navigation, planning, reasoning, inference, perception, control, and/or actuation operations of the machine 1200 in a variety of platforms and systems. For example, the SoC(s) 1204 may process live perception data (e.g., from camera, LiDAR, RADAR, ultrasonic, etc.) in addition to map data corresponding to one or more maps 1222 (e.g., HD map, SD map, navigational map, occupancy map, etc.) in order to make or aid in performing various operations of the machine 1200. Where a map and/or AI is used, map and/or AI (e.g., model parameter updates, fine-tuning, etc.) refreshes and/or updates via a network interface 1224 from one or more servers (e.g., server(s) 1278 of FIG. 12E)—such as one or more servers of a cloud-based data center.

Although an SoC(s) 1204 is illustrated throughout FIGS. 12A-12E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1200, use of the machine 1200, model of the machine 1200, and required capabilities of the machine 1200, one or more SoCs 1204 and/or alternative architectures and/or components may be used to satisfy the particular implementation.

The machine 1200 may include a CPU(s) 1218 (e.g., discrete CPU(s), or dCPU(s)), that may be coupled to the SoC(s) 1204 via a high-speed interconnect (e.g., PCIe). The CPU(s) 1218 may include an X86 processor, for example. The CPU(s) 1218 may be used to perform any of a variety of functions, including arbitrating potentially inconsistent results between ADAS sensors and the SoC(s) 1204, and/or monitoring the status and health of the controller(s) 1236 and/or infotainment SoC 1230, for example.

The machine 1200 may include a GPU(s) 1220 (e.g., discrete GPU(s), or dGPU(s)), that may be coupled to the SoC(s) 1204 via a high-speed interconnect (e.g., NVIDIA's NVLink). The GPU(s) 1220 may provide additional artificial intelligence functionality, such as by executing redundant and/or different neural networks, and may be used to train and/or update neural networks based on input (e.g., sensor data) from sensors of the machine 1200.

The machine 1200 may further include the network interface 1224 which may include one or more wireless antennas 1226 and/or modems (e.g., one or more wireless antennas for different communication protocols, such as a cellular antenna, a Bluetooth antenna, etc.). The network interface 1224 may be used to enable wireless connectivity over the Internet with the cloud (e.g., with the server(s) 1278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1200 information about vehicles in proximity to the machine 1200 (e.g., vehicles in front of, on the side of, and/or behind the machine 1200). This functionality may be part of a cooperative adaptive cruise control functionality of the machine 1200.

The network interface 1224 may include a SoC that provides modulation and demodulation functionality and enables the controller(s) 1236 to communicate over wireless networks. The network interface 1224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1226 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1200 may further include data store(s) 1228 which may include off-chip (e.g., off the SoC(s) 1204) storage. The data store(s) 1228 may include one or more storage elements including RAM, SRAM, DRAM, VRAM, Flash, hard disks, and/or other components and/or devices that may store at least one bit of data.

The machine 1200 may further include GNSS sensor(s) 1258. The GNSS sensor(s) 1258 (e.g., GPS, assisted GPS sensors, differential GPS (DGPS) sensors, etc.), to assist in mapping, perception, occupancy grid generation, and/or path planning functions. Any number of GNSS sensor(s) 1258 may be used, including, for example and without limitation, a GPS using a USB connector with an Ethernet to Serial (RS-232) bridge.

The machine 1200 may further include IMU sensor(s) 1266. The IMU sensor(s) 1266 may be located at a center of the rear axle of the machine 1200, in some examples. The IMU sensor(s) 1266 may include, for example and without limitation, an accelerometer(s), a magnetometer(s), a gyroscope(s), a magnetic compass(es), and/or other sensor types. In some examples, such as in six-axis applications, the IMU sensor(s) 1266 may include accelerometers and gyroscopes, while in nine-axis applications, the IMU sensor(s) 1266 may include accelerometers, gyroscopes, and magnetometers.

In some embodiments, the IMU sensor(s) 1266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1266 may enable the machine 1200 to estimate heading without requiring input from a magnetic sensor by directly observing and correlating the changes in velocity from GPS to the IMU sensor(s) 1266. In some examples, the IMU sensor(s) 1266 and the GNSS sensor(s) 1258 may be combined in a single integrated unit.

The vehicle may include one or more microphone 1296 placed in and/or around the machine 1200. The microphone(s) 1296 may be used for emergency vehicle detection and identification, among other things.

The machine 1200 may further include vibration sensor(s) 1242. The vibration sensor(s) 1242 may measure vibrations of components of the machine, such as the arms or legs of a humanoid robot 1200C, or the axle(s) of a vehicle 1200A or AMR 1200B. For example, changes in vibrations may indicate a change in road, walking, or traversable surfaces. In another example, when two or more vibration sensors 1242 are used, the differences between the vibrations may be used to determine friction or slippage of the surface (e.g., when the difference in vibration is between a power-driven axle and a freely rotating axle).

The machine 1200 may include an ADAS system 1238—such as when the machine 1200 is a vehicle 1200A. The ADAS system 1238 may include a dedicated SoC(s), in some examples. The ADAS system 1238 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1200 may further include the infotainment SoC 1230 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1200. For example, the infotainment SoC 1230 may radios, disk players, navigation systems, video players, USB and Bluetooth connectivity, carputers, in-car entertainment, Wi-Fi, steering wheel audio controls, hands free voice control, a heads-up display (HUD), an HMI display 1234, a telematics device, a control panel (e.g., for controlling and/or interacting with various components, features, and/or systems), and/or other components. The infotainment SoC 1230 may further be used to provide information (e.g., visual and/or audible) to a user(s) of the vehicle, such as information from the ADAS system 1238, autonomous driving information such as planned vehicle maneuvers, trajectories, surrounding environment information (e.g., intersection information, vehicle information, road information, etc.), and/or other information.

The infotainment SoC 1230 may include GPU functionality. The infotainment SoC 1230 may communicate over the bus 1202 (e.g., CAN bus, Ethernet, etc.) with other devices, systems, and/or components of the machine 1200. In some examples, the infotainment SoC 1230 may be coupled to a supervisory MCU such that the GPU of the infotainment system may perform some self-driving functions in the event that the primary controller(s) 1236 (e.g., the primary and/or backup computers of the machine 1200) fail. In such an example, the infotainment SoC 1230 may put the machine 1200 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1200—whether a vehicle 1200A, AMR 1200B, humanoid robot 1200C, and/or other type of machine—may include a locally stored language model(s) and/or communicate to a remotely hosted language model (e.g., via one or more APIs) to provide more detailed and in-depth communication features to the users of the machine(s) 1200.

In some examples, an infotainment SoC 1230, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1200. The always on sensor processing engine may be used to unlock the vehicle when the owner approaches the driver door and turn on the lights, and, in security mode, to disable the vehicle when the owner leaves the vehicle. In this way, the SoC(s) 1204 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1200.

The machine 1200 may further include an instrument cluster 1232 (e.g., a digital dash, an electronic instrument cluster, a digital instrument panel, etc.). The instrument cluster 1232 may include a controller and/or supercomputer (e.g., a discrete controller or supercomputer). The instrument cluster 1232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1230 and the instrument cluster 1232. In other words, the instrument cluster 1232 may be included as part of the infotainment SoC 1230, or vice versa.

FIG. 12D is a block diagram of an example architecture of a computing system (a subset of the system described with respect to FIG. 12C), in accordance with at least some embodiments of the present disclosure. Although illustrated as an SoC(s) 1204, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1204 may be an end-to-end platform with a flexible architecture that spans automation levels 2-5, or the SoC(s) 1204 may be specifically designed for a specific automation level (e.g., a first SoC 1204 for level 2 to level 2++, a second SoC 1204 for level 3, a third SoC 1204 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1204 may be faster, more reliable, and even more energy-efficient and space-efficient than conventional systems. For example, the accelerator(s) 1214, when combined with the CPU(s) 1206, the GPU(s) 1208, and the data store(s) 1216, may provide for a fast, efficient platform for level 2-5 autonomous vehicles as well as for safe planning, navigation, and control of AMRs 1200B, humanoid robots 1200C, and/or other robot or machine types.

In some embodiments, such as where the SoC(s) 1204 include a GPU 1208 with 2000 or more cores (e.g., 2048 cores), 60 or more tensor cores (e.g., 64 tensor cores), and a GPU max frequency of over 1 GHz (e.g., 1.3 GHz), a CPU 1206 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1209 (e.g., 2 DLAs/XNNs/NNAs/NPUs 1209), and a vision accelerator—such as a programmable vision accelerator (PVA) 1207, a single SoC 1204) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1204 include a GPU 1208 with 1700 or more cores (e.g., 1792 cores), 50 or more tensor cores (e.g., 56 tensor cores), and a GPU max frequency of over 900 MHz (e.g., 930 MHz), a CPU 1206 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1209 (e.g., 2 DLAs/XNNs/NNAs/NPUs 1209), and a vision accelerator—such as a programmable vision accelerator (PVA) 1207, a single SoC 1204) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1204 include a GPU 1208 with 1000 or more cores (e.g., 1024 cores), 28 or more tensor cores (e.g., 32 tensor cores), and a GPU max frequency of over 900 MHz (e.g., 1173 MHz), a CPU 1206 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 1209 (e.g., 1 DLA/XNN/NNA/NPU 1209), and a vision accelerator—such as a programmable vision accelerator (PVA) 1207, a single SoC 1204) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1204 include a GPU 1208 with 1000 or more cores (e.g., 1024 cores), 28 or more tensor cores (e.g., 32 tensor cores), and a GPU max frequency of over 900 MHz (e.g., 1020 MHz), a CPU 1206 including 6 or more cores (e.g., 6 cores), with 64 bits, 1.5 MB L2 and 4 MB L3 cache memory, and a max frequency of 1.5 or more GHz (e.g., 1.7 GHz), a single SoC 1204) may be capable of 67 tera operations per second (TOPS) of AI performance. For example, NVIDIA's Jetson Orin Nano 8 GB SoC satisfies these criteria, and achieves this performance.

The SoC(s) 1204 may include one or more CPUs 1206. The CPU(s) 1206 may include a CPU cluster or CPU complex (alternatively referred to herein as a “CCPLEX”), in embodiments. The CPU(s) 1206 may include multiple cores and/or (e.g., L2, L3) caches. For example, in some embodiments, the CPU(s) 1206 may include twelve cores in a coherent multi-processor configuration. In some embodiments, the CPU(s) 1206 may include four dual-core clusters where each cluster has a dedicated L2 cache (e.g., a 3 MB L2 cache). The CPU(s) 1206 (e.g., the CCPLEX) may be configured to support simultaneous cluster operation enabling any combination of the clusters of the CPU(s) 1206 to be active at any given time.

The SoC(s) 1204 may include any type and number of GPUs 1208. For example, an integrated GPU(s) (alternatively referred to herein as an “iGPU(s)”) may be used in some embodiments. The GPU(s) 1208 may be programmable and may be efficient for parallel workloads. The GPU(s) 1208, in some examples, may use an enhanced tensor instruction set. The GPU(s) 1208 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1208 may include at least eight streaming microprocessors. The GPU(s) 1208 may use compute application programming interface(s) (API(s)). In addition, the GPU(s) 1208 may use one or more parallel computing platforms and/or programming models (e.g., NVIDIA's CUDA).

The GPU(s) 1208 may be power-optimized for best performance in automotive, robotics, and/or other embedded use cases. For example, the GPU(s) 1208 may be fabricated on a Fin field-effect transistor (FinFET). However, this is not intended to be limiting and the GPU(s) 1208 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1208 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1208 to access the CPU(s) 1206 page tables directly. In such examples, when the GPU(s) 1208 memory management unit (MMU) experiences a miss, an address translation request may be transmitted to the CPU(s) 1206. In response, the CPU(s) 1206 may look in its page tables for the virtual-to-physical mapping for the address and transmits the translation back to the GPU(s) 1208. As such, unified memory technology may allow a single unified virtual address space for memory of both the CPU(s) 1206 and the GPU(s) 1208, thereby simplifying the GPU(s) 1208 programming and porting of applications to the GPU(s) 1208.

The SoC(s) 1204 may include any number of cache(s) 1212, including those described herein. For example, the cache(s) 1212 may include L0 caches, L1 caches, L2 caches, L3 caches (e.g., that are available to both the CPU(s) 1206 and the GPU(s) 1208 (e.g., that is connected both the CPU(s) 1206 and the GPU(s) 1208)), etc. The cache(s) 1212 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1204 may include one or more arithmetic logic units (ALUs) 1265 which may be leveraged in performing processing with respect to any of the variety of tasks or operations of the machine 1200—such as computer vision, machine learning or deep learning processing, world model management, etc. In addition, the SoC(s) 1204 may include a floating point unit(s) (FPU(s)) 1267—or other math coprocessor or numeric coprocessor types—for performing mathematical operations within the system. For example, the SoC(s) 104 may include one or more FPUs 1267 integrated as execution units within a CPU(s) 1206 and/or GPU(s) 1208.

The SoC(s) 1204 may include one or more accelerators 1214 (e.g., hardware accelerators, software accelerators, or a combination thereof). For example, the SoC(s) 1204 may include a hardware acceleration cluster that may include optimized hardware accelerators and/or large on-chip memory. The large on-chip memory 1215 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1208 and to off-load some of the tasks of the GPU(s) 1208 (e.g., to free up more cycles of the GPU(s) 1208 for performing other tasks). As an example, the accelerator(s) 1214 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1214 (e.g., the hardware acceleration cluster) may include a deep learning accelerator(s) (DLA) 1209 (alternatively referred to herein as “a deep learning accelerator cluster (XNN) 1209,” “neural network accelerator (NNA) 1209,” or “neural processing unit (NPU) 1209”). The DLA(s) 1209 may include one or more Tensor processing units (TPUs) 1241 that may be configured to provide an additional, e.g., ten trillion operations per second for deep learning applications and inferencing. The TPUs 1241 may be accelerators configured to, and optimized for, performing image processing functions (e.g., for CNNs, RCNNs, DNNs, etc.). The DLA(s) 1209 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1241 may perform several functions, including a single-instance convolution function, supporting, for example, INT8, INT16, and FP16 data types for both features and weights, as well as post-processor functions. Although the TPU(s) 1241 are described as being included as part of the DLA(s) 1209, this is not intended to be limiting, and the TPU(s) 1241 may be included in additional or alternative accelerator(s) 1214 and/or other components, and/or may be included as a discrete processing component(s).

The DLA(s) 1209 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1209 may perform any function of the GPU(s) 1208, and by using an inference accelerator, for example, a designer may target either the DLA(s) 1209 or the GPU(s) 1208 for any function. For example, the designer may focus processing of DNNs and floating point operations on the DLA(s) 1209 and leave other functions to the GPU(s) 1208 and/or other accelerator(s) 1214. The DLA(s) 1209 may be used to run any type of network to enhance control and safety, including for example, a neural network that outputs a measure of confidence for each object detection.

The accelerator(s) 1214 (e.g., the hardware acceleration cluster) may include a programmable vision accelerator(s) (PVA) 1207, which may alternatively be referred to herein as a computer vision accelerator or generally a vision accelerator. The PVA(s) 1207 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1207 may provide a balance between performance and flexibility. For example, each PVA(s) 1207 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1207 may be optimized for the tasks of image processing and computer vision algorithm acceleration. For example, the PVA(s) 1207 provides excellent performance with extremely low power consumption, and can be used asynchronously and concurrently with the CPU(s) 1206, GPU(s) 1208, and/or other accelerators in the system (e.g., vehicle, robot, etc.) as part of a heterogeneous compute pipeline.

The PVA(s) 1207 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 1243 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 1206 (e.g., ARM Cortex-R5 processor), facilitating data exchange with the CPU(s) 1206 and other system-level components. The VPU I-cache may supply instruction data to the VPU(s) when requested, may request missing instruction data from system memory, and/or may maintain temporary instruction storage for the VPU. For each VPU task, the CPU(s) 1206 may configures the DMA system, optionally prefetch the VPU program into VPU I-cache, and/or kick off each VPU-DMA pair to process a task. The PVA(s) 1207 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1207 to access the system memory independently of the CPU(s) 1206. The DMA may support any number of features used to provide optimization to the PVA(s) 1207 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1207 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1207, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1207 may be configured to employ data parallelism. For example, in some embodiments, the plurality of vector processors included in a single PVA(s) 1207 may execute the same computer vision algorithm, but on different regions of an image. In other examples, the vector processors included in a particular PVA(s) 1207 may simultaneously execute different computer vision algorithms, on the same image, or even execute different algorithms on sequential images or portions of an image. Among other things, any number of PVAs 1207 may be included in the hardware acceleration cluster and any number of vector processors may be included in each of the PVAs. In addition, the PVA(s) 1207 may include additional error correcting code (ECC) memory, to enhance overall system safety.

The accelerator(s) 1214 (e.g., the hardware accelerator cluster) have a wide array of uses for autonomous and semi-autonomous machine control. The PVA(s) 1207 may be a programmable vision accelerator that may be used for key processing stages in perception, robotics understanding and reasoning, ADAS, semi-autonomous, and autonomous vehicles, etc. The PVA's 1207 capabilities are a good match for algorithmic domains needing predictable processing, at low power and low latency. In other words, the PVA(s) 1207 performs well on semi-dense or dense regular computation, even on small data sets, which need predictable run-times with low latency and low power. Thus, in the context of platforms for autonomous vehicles and robotics, the PVAs 1207 are designed to run classic computer vision algorithms, as they are efficient at object detection and operating on integer math.

For example, according to one embodiment of the technology, the PVA 1207 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1207 may perform computer stereo vision function on inputs from two monocular cameras.

In some examples, the PVA(s) 1207 may be used to perform dense optical flow. According to process raw RADAR data (e.g., using a 4D Fast Fourier Transform) to provide Processed RADAR. In other examples, the PVA(s) 1207 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1207, this is not intended to be limiting. In some embodiments, these components may be included in alternative or additional processing components and/or accelerator(s) 1214, and/or may be included as discrete components of the SoC(s) 1204 and/or other computing system architecture(s).

In some examples, the SoC(s) 1204 may include a real-time ray-tracing hardware accelerator (RTA) 1251 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1200 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1251 and/or a ray-tracing optimized GPU 1206—such as NVIDIA's RTX GPU.

The accelerator(s) 1214 (e.g., in the hardware acceleration cluster) may include one or more optical flow accelerators (OFAs) 1211. For example, the OFA(s) 1211 may be used for computing optical flow and stereo disparity between frames of sensor data (e.g., images). Optical flow may be accelerated on the OFA(s) 1211 for uses such as object detection and tracking, and/or for stereo depth estimation where used for computing stereo disparity between stereo image frames (e.g., two or more frames captured using two or more image sensors with at least partially overlapping fields of view).

The SoC(s) 1204 may include one or more camera serial interfaces (CSIs) 1223. For example, the CSI(s) 1223 may include a mobile industry processor interface (MIPI) camera serial interface (CSI) for receiving video and input from cameras, a high-speed interface, and/or a video input block that may be used for camera and related pixel input functions. The SoC(s) 1204 may further include an input/output controller(s) that may be controlled by software and may be used for receiving I/O signals that are uncommitted to a specific role. For example, the CSI 1223 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 1214 (e.g., the hardware acceleration cluster) may include a computer vision network on-chip (CVNOC) 1263 and SRAM, for providing a high-bandwidth, low latency SRAM for the accelerator(s) 1214. In some examples, the on-chip memory may include at least 4 MB SRAM, consisting of, for example and without limitation, eight field-configurable memory blocks, that may be accessible by the PVA 1207, OFA 1211, DLA 1209, and/or other accelerator(s) 1214. Each pair of memory blocks may include an advanced peripheral bus (APB) interface, configuration circuitry, a controller, and a multiplexer. Any type of memory 1215 may be used. The PVA 1207, OFA 1211, DLA 1209, and/or other accelerator(s) 1214 may access the memory via a backbone that provides the accelerator(s) 1214 with high-speed access to memory. The backbone may include a computer vision network on-chip that interconnects the accelerator(s) 1214 to the memory (e.g., using the APB).

The CVNOC 1263 may include an interface that determines, before transmission of any control signal/address/data, that the accelerator(s) 1214 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1204 may include data store(s) 1216 and/or memory 1215. The data store(s) 1216 may be on-chip memory 1215 of the SoC(s) 1204, which may store neural networks and/or other algorithms to be executed on the CPU(s) 1206, the GPU(s) 1208, and/or one or more of the accelerator(s) 1214. In some examples, the data store(s) 1216 may be large enough in capacity to store multiple instances of neural networks for redundancy and safety. The data store(s) 1212 may comprise L2 and/or L3 cache(s) 1212, for example. The memory(ies) 1215 may include SRAM, LPDDR5, and/or other memory types. For example, the memory(ies) 1215 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 1216 may include reference to the memory associated with the PVA 1207, OFA 1211, DLA 1209, and/or other accelerator(s) 1214, as described herein.

The data store(s) 116 may include various storage types, such as eMMC, NVMe, etc. For example, the SoC(s) 1204 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1216 and/or other storage may be accessed via, e.g., NVMe, using PCI Express (PCIe), RDMA, TCP, and/or other protocols.

The SoC(s) 1204 may include one or more processor(s) 1210 (e.g., embedded processors). The processor(s) 1210 may include a boot and power management processor (BPMP) 1253, that may be a dedicated processor and subsystem to handle boot power and management functions and related security enforcement. The BPMP 1253 may be a part of the SoC(s) 1204 boot sequence and may provide runtime power management services. The BPMP 1253 may provide clock and voltage programming, assistance in system low power state transitions, management of SoC(s) 1204 thermals and temperature sensors, and/or management of the SoC(s) 1204 power states. Each temperature sensor may be implemented as a ring-oscillator whose output frequency is proportional to temperature, and the SoC(s) 1204 may use the ring-oscillators to detect temperatures of the CPU(s) 1206, GPU(s) 1208, accelerator(s) 1214, and/or other components. If temperatures are determined to exceed a threshold, BPMP 1253 may enter a temperature fault routine and put the SoC(s) 1204 into a lower power state and/or put the machine 1200 into a chauffeur to safe stop mode (e.g., bring the machine 1200 to a safe stop).

The processor(s) 1210 may further include a set of embedded processors that may serve as an audio processing engine (APE) 1255. The APE 1255 may be an audio subsystem that enables full hardware support for multi-channel audio over multiple interfaces, and a broad and flexible range of audio I/O interfaces. In some examples, the APE 1255 is a dedicated processor core with a digital signal processor with dedicated RAM.

The processor(s) 1210 may further include an always on processor engine (AOPE) 1257 that may provide necessary hardware features to support low power sensor management and wake use cases. The AOPE 1257 may include a processor core, a tightly coupled RAM, supporting peripherals (e.g., timers and interrupt controllers), various I/O controller peripherals, and routing logic.

The processor(s) 1210 may further include a safety processor(s) 1213 (alternatively referred to as “safety island 1213”), which may include a safety cluster engine that includes a dedicated processor or processor subsystem to handle safety management for automotive, robotics, and/or other applications. The safety processor(s) 1213—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1213 may include a discrete processor(s), such that fault of other system components may not impact the performance and availability of the safety processor 1213.

The processor(s) 1210 may further include a real-time or near real-time sensor engine (SE) 1259 that may include a dedicated processor subsystem for handling real-time or near real-time camera, LiDAR, RADAR, and/or other sensor modality management.

The processor(s) 1210 may further include one or more image signal processors (ISPs) 1227, which may include a high-dynamic range signal processor and/or a hardware engine that is part of one or more sensor processing pipelines.

The processor(s) 1210 may include a video image compositor (VIC) 1261 that may be a processing block (e.g., implemented on a microprocessor) that implements video post-processing functions needed by a video playback application to produce the final image for the player window. The VIC 1261 may perform lens distortion correction on wide-view camera(s) 1268B, surround camera(s) 1268D, in-cabin monitoring camera sensors, and/or other camera sensors with distorted fields of view.

A VIC 1261 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1261 may also be configured to perform stereo rectification on input stereo lens frames. The video image compositor may further be used for user interface composition when the operating system desktop is in use, and the GPU(s) 1208 is not required to continuously render new surfaces. Even when the GPU(s) 1208 is powered on and active doing 3D rendering, the video image compositor may be used to offload the GPU(s) 1208 to improve performance and responsiveness.

The SoC(s) 1204 may further include a broad range of peripheral interfaces for input/output (I/O) 1225, such as to enable communication with peripherals, audio codecs, power management, and/or other devices. The SoC(s) 1204 may be used to process data from cameras (e.g., connected over Gigabit Multimedia Serial Link and/or Ethernet), sensors (e.g., LiDAR sensor(s) 1264, RADAR sensor(s) 1260, etc. that may be connected over Ethernet), data from bus 1202 (e.g., speed of machine 1200, steering wheel position, etc.), data from GNSS sensor(s) 1258 (e.g., connected over Ethernet or CAN bus). The SoC(s) 1204 may further include dedicated high-performance mass storage controllers that may include their own DMA engines, and that may be used to free the CPU(s) 1206 from routine data management tasks. In some embodiments, the SoC(s) 1204 I/O 1225 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1225 elements, components, or features.

The SoC(s) 1204 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1204 may include an RJ45 connector with up to 10 GbE, a 1 GbE connector, and/or other networking connector types.

The SoC(s) 104 may include one or more digital signal processors (DSPs) 1243. For example, the DSP(s) 1243 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 1204 may include one or more video encoders 1219 and/or one or more video decoders 1221. For example, the video encoder(s) 1219 may include a hardware-based (e.g., as part of the GPU(s) 1208) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1221 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1221 may be hardware-based (e.g., as part of the GPU(s) 1208).

The SoC(s) 1204 may include one or more general compute acceleration clusters (GCAC(s)) 1229. For example, the GCAC(s) 1229 may include various processor types that may be used to accelerate compute, such as one or more vector microcode processors (VMPs) 1233, one or more multi-threaded processing clusters (MPCs) 1231, one or more programmable macro arrays (PMA(s)) 1235, and/or one or more other processor types. For example, the GCAC(s) 1229 may include a PMA 1235, two VMPs 1233, and 2 MPCs 1231.

The SoC(s) 1204 may include one or more vector microcode processors (VMPs) 1233. The VMP(s) 1233, in embodiments, may include a wide vector (very long instruction word (VLIW) and single instruction multiple data (SIMD)) machine with performing various operations, such as short integral type operations common in computer vision and deep learning algorithms.

The SoC(s) 1204 may include one or more multi-threaded processing clusters (MPCs) 1231. The MPC(s) 1231 may include a processing cluster that be, in embodiments, more versatile than a GPU, and with higher efficiency than a CPU. For example, the MPC(s) 1231 may include a multi-threaded processor that allows multiple threads to share resources and execute instructions concurrently.

The SoC(s) 1204 may include one or more programmable macro arrays (PMA(s)) 1235. The PMA(s) 1235 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1204 may include one or more display processing units (DPUs) 1245 for performing hardware-accelerated image processing. For example, the DPU(s) 1245 may retrieve pixel data from memory 1215 and send it to a display peripheral through standard interfaces. As such, the DPU(s) 1245 may handle display processing and rendering for in-machine and/or on-machine displays.

The SoC(s) 1204 may include one or more application processing units (APUs) 1239. For example, the APU(s) 1239 may include a quad or dual-core processor with 48 KB/32 KB L1 cache with parity and ECC, along with a 1 MB L2 cache with ECC. The APU(s) 1239 may support NEON instructions and single and double precision floating point operations.

The SoC(s) 1204 may include one or more real-time processing units (RTPUs) 1269. The RTPU(s) 1269 may include a dual-core processor with 32 KB/32 KB L1 cache, and 256 KB TCM with ECC. The RTPU(s) 1269 may support single and double precision floating point operations.

The SoC(s) 1204 may include one or more built-in self-test (BIST) components 1237. For example, the BIST component(s) 1237 may include memory BIST (MBIST) to test memories of the system and/or logic BIST (LBIST) to test logic of the system. The BIST components 1237 may include embedded logic for directly testing logic and/or memory of the system.

The SoC(s) 1204 may include one or more dynamically reconfigurable processors (DRPs) 1271. For example, the DRP(s) 1271 may be used for accelerating various computing operations. For example, the DRP(s) 1271 may be combined, in embodiments, with a MAC unit for use as an AI accelerator. In embodiments, the DRP(s) 1271 may execute applications while dynamically switching the circuit connection configuration of the arithmetic units (e.g., ALUs) on the chip at each operating clock according to the content to be processed. Since only the necessary arithmetic circuits are used, the DRP(s) 1271 may consume less power than with CPU processing and can achieve higher speed. Furthermore, compared to CPUs, where frequent external memory accesses due to cache misses and other causes will degrade performance, the DRP(s) 1271 can build the necessary data paths in hardware ahead of time, resulting in less performance degradation and less variation in operating speed (jitter) due to memory accesses. The DRP(s) 1271 may include a dynamic loading function that switches the circuit connection information each time the algorithm changes, enabling processing with limited hardware resources, even in robotic/automotive applications that require processing of multiple algorithms.

In some embodiments, the accelerator(s) 1214 may include an OpenCV accelerator for speeding up processing of OpenCV, an open-source industry standard library for computer vision processing. In some embodiments, the combination of one or more DRP(s) 1271 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1204 may include various compute engines (e.g., processors 1210, CPUs 1206, GPU(s) 1208, accelerator(s) 1214, etc.), tasks may be distributed between and among the compute engines, in some instances without common cause failures due to the discrete footprint of the compute engines. Further, because the SoC(s) 1204 may include a dedicated safety processor(s) 1213 (or safety island 1213), critical safety or redundant operations may be performed without common cause failures from the main processing components or compute engines of the SoC(s) 1214. Due to these features, the SoC(s) 1204 and/or the underlying systems of the machine 1200 may be capable of satisfying higher levels of safety—such as automotive safety integrity level (ASIL) D from the ISO 26262 standard.

FIG. 12E is a system diagram for communication between a cloud-based server(s) (e.g., in a data center, such as those described herein) and the example autonomous or semi-autonomous vehicle or machine 1200 of FIG. 12A, in accordance with some embodiments of the present disclosure. The system 1276 may include a server(s) 1278, a network(s) 1290, and a machine(s) 1200. The server(s) 1278 may include a plurality of GPUs 1284(A)-1284(H) (collectively referred to herein as GPUs 1284), switches 1282(A)-1282(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 1280(A)-1280(B) (collectively referred to herein as CPUs 1280), accelerators, and/or other processor types. The GPUs 1284, the CPUs 1280, and the PCIe switches may be interconnected with high-speed interconnects such as, for example and without limitation, NVLink interfaces 1288 developed by NVIDIA and/or PCIe connections 1286. In some examples, the GPUs 1284 are connected via NVLink and/or NVSwitch SoC and the GPUs 1284 and the PCIe switches 1282 are connected via PCIe interconnects. Although eight GPUs 1284, two CPUs 1280, and two PCIe switches are illustrated, this is not intended to be limiting. Depending on the embodiment, each of the server(s) 1278 may include any number of GPUs 1284, CPUs 1280, and/or PCIe switches. For example, the server(s) 1278 may each include eight, sixteen, thirty-two, and/or more GPUs 1284.

The server(s) 1278 may receive, over the network(s) 1290 and from the machine(s) 1200, sensor data indicating information about new or previously unexplored locations, and/or sensor data indicating changes to previously seen/stored locations (e.g., unexpected or changed road conditions, such as recently commenced road-work). The server(s) 1278 may transmit, over the network(s) 1290 and to the machine(s) 1200, neural networks 1292, updated neural networks 1292, map information 1294, etc., including information regarding traffic and road conditions. The updates to the map information 1294 may include updates for the HD map 1222, SD map, navigation map, etc., such as information regarding construction sites, potholes, detours, flooding, and/or other obstructions. In some examples, the neural networks 1292, the updated neural networks 1292, the map information 1294, and/or the other information may have resulted from new training and/or experiences represented in data received from any number of machine(s) 1200 in the environment, and/or based on training performed at a datacenter (e.g., using the server(s) 1278 and/or other servers).

The server(s) 1278 may be used to train machine learning models (e.g., neural networks) based on training data. The training data may be generated by the machine(s) 1200, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1200 (e.g., transmitted to the machine(s) 1200 over the network(s) 1290, and/or the machine learning models may be used by the server(s) 1278 to remotely monitor and/or control the machine(s) 1200.

In some examples, the server(s) 1278 may receive data from the machine(s) 1200 and apply the data to up-to-date real-time neural networks for real-time intelligent inferencing. The server(s) 1278 may include deep-learning supercomputers and/or dedicated AI computers powered by GPU(s) 1284, such as a DGX and DGX Station machines developed by NVIDIA. However, in some examples, the server(s) 1278 may include deep learning infrastructure that use only CPU-powered datacenters.

The deep-learning infrastructure of the server(s) 1278 may be capable of fast, real-time inferencing, and may use that capability to evaluate and verify the health of the processors, software, and/or associated hardware in the machine 1200. For example, the deep-learning infrastructure may receive periodic updates from the machine 1200, such as a sequence of images and/or objects that the machine 1200 has located in that sequence of images (e.g., via computer vision and/or other machine learning object classification techniques). The deep-learning infrastructure may run its own neural network to identify the objects and compare them with the objects identified by the machine 1200 and, if the results do not match and the infrastructure concludes that the AI in the machine 1200 is malfunctioning, the server(s) 1278 may transmit a signal to the machine 1200 instructing a fail-safe computer of the machine 1200 to assume control, notify the passengers, and complete a safety maneuver or operation—such as to slow down, hand control back to a driver, come to a stop, and/or pull over/shut down.

For inferencing, the server(s) 1278 may include the GPU(s) 1284 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 13 is a system diagram illustrating a three computer ecosystem 1300, including a first computing system 1302 for generating or creating artificial intelligence (AI)—such as AI training and validation data, a second computing system 1304 for training artificial intelligence, and a third computing system 1306 (which may include or correspond to the SoC(s) 1204 of FIGS. 12A-12E) deploying the AI at the edge, in accordance with at least some embodiments of the present disclosure. For example, to develop and deploy embodied or physical AI, the three computer ecosystem 1300 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1200 and their worlds. By doing so, simulation of machine(s) 1200 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 1200 can perform safely in controlled settings.

The computing system 1304 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 1200 to understand natural language and emulate movements by observing human actions. The computing system 1304 may include a platform that incorporates software, infrastructure, and expertise in a modern, unified AI development and training solution. The computing system 1304 may include individual computing devices 1310 (e.g., NVIDIA's DGX B200, H200, etc.) and/or any number of computing devices 1310 in a data center infrastructure 1312 (e.g., NVIDIA's DGX SuperPOD).

For example, the individual computing devices 1310 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1310 may include memory (e.g., 4 TB memory, and storage (e.g., OS storage of 2×1.9 TB NVMe M.2, and internal storage of 8×3.84 TB NVMe U.2). The computing devices 1310 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1310 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 1310 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1310 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1310 may include a smart host channel adapter (HCA) (e.g., NVIDIA's ConnectX-7) to provide ultra-low latency, 400 Gb/s throughput for in-network computing acceleration engines.

The data center infrastructure 1312 may include any number of the computing devices 1310, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1310) to thousands, job scheduling and orchestration to ensure hassle-free execution of every developer's job, AI workflow management and machine learning operations (MLOps) to move more models from prototype to production, and enterprise software to speed developer success.

The computing system 1302 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1302 allows developers to use simulation frameworks to simulate and validate robot models, and/or to generate massive amounts of physically-based synthetic data to bootstrap model training. The computing system 1302 may support learning frameworks that power robot reinforcement learning and imitation learning, to accelerate robot policy training and refinement. For example, the computing system 1302 may be used to generate any number of simulations 1308—such as within NVIDIA's OMNIVERSE. The computing system 1302 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1302 may host or support a native OpenUSD software platform enabling enterprises to connect 3D pipelines and develop advanced, real-time 3D applications for industrial digitalization. With powerful ray-tracing-accelerated AI and graphics capabilities, the computing system 1302 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1302 may include individual computing devices 1314 (e.g., NVIDIA's OVX L40S Server) and/or any number of computing devices 1314 in a data center infrastructure 1316 (e.g., NVIDIA's OVX Systems).

The computing device(s) 1314 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16: 64 GB/s bidirectional interconnect interface, 18,176 CUDA cores, 142 ray tracing (RT) cores, and 568 tensor cores). The computing devices 1314 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 1314 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1314 may include a smart host channel adapter (HCA) (e.g., NVIDIA's ConnectX-7) to provide ultra-low latency, 400 Gb/s throughput for in-network computing acceleration engines. The computing device(s) 1314 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1312, the data center infrastructure 1316 may allow for any number of computing device(s) 1314 to be combined in cluster configuration according to a reference architecture.

The computing system 1306 may be used to deploy trained AI models on a runtime computer—such as the SoC(s) 1204 described herein. For example, these computing systems 1306 may be designed for compact, on-board computing needs, including an ensemble of models for control policy, vision and language models, etc., deployed on a power-efficient on-board edge computing system 1306. Details of components, features, and capabilities of the computing system 1306 may be described in more detail herein with respect to FIGS. 12A-12E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 14 is a block diagram of an example generative language model system 1400 suitable for use in implementing at least some embodiments of the present disclosure. In the example illustrated in FIG. 14, the generative language model system 1400 includes a retrieval augmented generation (RAG) component 1492, an input processor 1405, a tokenizer 1410, an embedding component 1420, plug-ins/APIs 1495, and a generative language model (LM) 1430 (which may include an LLM, a VLM, a MMLM, a VLA model, etc.).

At a high level, the input processor 1405 may receive an input 1401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1430 (e.g., LLM/VLM/MMLM/etc.). In some embodiments, the input 1401 includes plain text in the form of one or more sentences, paragraphs, and/or documents. Additionally or alternatively, the input 1401 may include numerical sequences, precomputed embeddings (e.g., word or sentence embeddings), and/or structured data (e.g., in tabular formats, JSON, or XML). In some implementations in which the generative LM 1430 is capable of processing multi-modal inputs, the input 1401 may combine text (or may omit text) with image data, audio data, video data, design data, USD data, and/or other types of input data, such as but not limited to those described herein. Taking raw input text as an example, the input processor 1405 may prepare raw input text in various ways. For example, the input processor 1405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1405 may remove stopwords to reduce noise and focus the generative LM 1430 on more meaningful content. The input processor 1405 may apply text normalization (TN), for example, by converting all characters to lowercase, removing accents, and/or or handling special cases like contractions or abbreviations to ensure consistency (e.g., converting ¼ to one quarter). Similarly, the input processor 1405 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1492 (which may include one or more RAG models, and/or may be performed using the generative LM 1430 itself) may be used to retrieve additional information to be used as part of the input 1401 or prompt. RAG may be used to enhance the input to the LLM/VLM/MMLM/etc. with external knowledge, so that answers to specific questions or queries or requests are more relevant—such as in a case where specific knowledge is required. The RAG component 1492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1401 may be generated using the query or input to the model (e.g., a question, a request, etc.) in addition to data retrieved using the RAG component 1492. In some embodiments, the input processor 1405 may analyze the input 1401 and communicate with the RAG component 1492 (or the RAG component 1492 may be part of the input processor 1405, in embodiments) in order to identify relevant text and/or other data to provide to the generative LM 1430 as additional context or sources of information from which to identify the response, answer, or output 1490, generally. For example, where the input indicates that the user is interested in a desired tire pressure for a particular make and model of vehicle, the RAG component 1492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1492 may retrieve a prior stored conversation history—or at least a summary thereof—and include the prior conversation history along with the current ask/request as part of the input 1401 to the generative LM 1430.

The RAG component 1492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1492 and the embeddings of the chunks along with the embeddings of the query may be compared to identify the most similar/related embeddings to the query, which may be supplied to the generative LM 1430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1430 to understand morphological variations and handle out-of-vocabulary words more effectively. Character-based tokenization represents each character as a separate token, enabling the generative LM 1430 to process text at a fine-grained level. The choice of tokenization strategy may depend on factors such as the language being processed, the task at hand, and/or characteristics of the training dataset. As such, the tokenizer 1410 may convert the (e.g., processed) text into a structured format according to tokenization schema being implemented in the particular embodiment.

The embedding component 1420 may use any known embedding technique to transform discrete tokens into (e.g., dense, continuous vector) representations of semantic meaning. For example, the embedding component 1420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1401 includes image data/video data/etc., the input processor 1401 may resize the data to a standard size compatible with format of a corresponding input channel and/or may normalize pixel values to a common range (e.g., 0 to 1) to ensure a consistent representation, and the embedding component 1420 may encode the image data using any known technique (e.g., using one or more convolutional neural networks (CNNs) to extract visual features). In some implementations in which the input 1401 includes audio data, the input processor 1401 may resample an audio file to a consistent sampling rate for uniform processing, and the embedding component 1420 may use any known technique to extract and encode audio features—such as in the form of a spectrogram (e.g., a mel-spectrogram). In some implementations in which the input 1401 includes video data, the input processor 1401 may extract frames or apply resizing to extracted frames, and the embedding component 1420 may extract features such as optical flow embeddings or video embeddings and/or may encode temporal information or sequences of frames. In some implementations in which the input 1401 includes multi-modal data, the embedding component 1420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1430 and/or other components of the generative LM system 1400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1420 may apply an encoded representation of the input 1401 to the generative LM 1430, and the generative LM 1430 may process the encoded representation of the input 1401 to generate an output 1490, which may include responsive text and/or other types of data.

As described herein, in some embodiments, the generative LM 1430 may be configured to access or use—or capable of accessing or using—plug-ins/APIs 1495 (which may include one or more plug-ins, application programming interfaces (APIs), databases, data stores, repositories, etc.). For example, for certain tasks or operations that the generative LM 1430 is not ideally suited for, the model may have instructions (e.g., as a result of training, and/or based on instructions in a given prompt, such as those retrieved using the RAG component 1492) to access one or more plug-ins/APIs 1495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1495 to the plug-in/API 1495, the plug-in/API 1495 may process the information and return an answer to the generative LM 1430, and the generative LM 1430 may use the response to generate the output 1490. This process may be repeated—e.g., recursively—for any number of iterations and using any number of plug-ins/APIs 1495 until an output 1490 that addresses each ask/question/request/process/operation/etc. from the input 1401 can be generated. As such, the model(s) may not only rely on its own knowledge from training on a large dataset(s) and/or from data retrieved using the RAG component 1492, but also on the expertise or optimized nature of one or more external resources—such as the plug-ins/APIs 1495.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 15 is a block diagram of an example computing device(s) 1500 suitable for use in implementing some embodiments of the present disclosure. Computing device 1500 may include an interconnect system 1502 that directly or indirectly couples the following devices: memory 1504, one or more central processing units (CPUs) 1506, one or more graphics processing units (GPUs) 1508, a communication interface 1510, input/output (I/O) ports 1512, input/output components 1514, a power supply 1516, one or more presentation components 1518 (e.g., display(s), speaker(s), etc.), and one or more logic units 1520. In at least one embodiment, the computing device(s) 1500 may comprise one or more virtual machines (VMs), and/or any of the components thereof may comprise virtual components (e.g., virtual hardware components). For non-limiting examples, one or more of the GPUs 1508 may comprise one or more vGPUs, one or more of the CPUs 1506 may comprise one or more vCPUs, and/or one or more of the logic units 1520 may comprise one or more virtual logic units. As such, a computing device(s) 1500 may include discrete components (e.g., a full GPU dedicated to the computing device 1500), virtual components (e.g., a portion of a GPU dedicated to the computing device 1500), or a combination thereof.

Although the various blocks of FIG. 15 are shown as connected via the interconnect system 1502 with lines, this is not intended to be limiting and is for clarity only. For example, in some embodiments, a presentation component 1518, such as a display device, may be considered an I/O component 1514 (e.g., if the display is a touch screen). As another example, the CPUs 1506 and/or GPUs 1508 may include memory (e.g., the memory 1504 may be representative of a storage device in addition to the memory of the GPUs 1508, the CPUs 1506, and/or other components). As such, the computing device of FIG. 15 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 15.

The interconnect system 1502 may represent one or more links or busses, such as an address bus, a data bus, a control bus, or a combination thereof. The interconnect system 1502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1506 may be directly connected to the memory 1504. Further, the CPU 1506 may be directly connected to the GPU 1508. Where there is direct, or point-to-point connection between components, the interconnect system 1502 may include a PCIe link to carry out the connection. In these examples, a PCI bus need not be included in the computing device 1500.

The memory 1504 may include any of a variety of computer-readable media. The computer-readable media may be any available media that may be accessed by the computing device 1500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1506 may be configured to execute at least some of the computer-readable instructions to control one or more components of the computing device 1500 to perform one or more of the methods and/or processes described herein. The CPU(s) 1506 may each include one or more cores (e.g., one, two, four, eight, twenty-eight, seventy-two, etc.) that are capable of handling a multitude of software threads simultaneously. The CPU(s) 1506 may include any type of processor, and may include different types of processors depending on the type of computing device 1500 implemented (e.g., processors with fewer cores for mobile devices and processors with more cores for servers). For example, depending on the type of computing device 1500, the processor may be an Advanced RISC Machines (ARM) processor implemented using Reduced Instruction Set Computing (RISC) or an x86 processor implemented using Complex Instruction Set Computing (CISC). The computing device 1500 may include one or more CPUs 1506 in addition to one or more microprocessors or supplementary co-processors, such as math co-processors.

In addition to or alternatively from the CPU(s) 1506, the GPU(s) 1508 may be configured to execute at least some of the computer-readable instructions to control one or more components of the computing device 1500 to perform one or more of the methods and/or processes described herein. One or more of the GPU(s) 1508 may be an integrated GPU (e.g., with one or more of the CPU(s) 1506 and/or one or more of the GPU(s) 1508 may be a discrete GPU. In embodiments, one or more of the GPU(s) 1508 may be a coprocessor of one or more of the CPU(s) 1506. The GPU(s) 1508 may be used by the computing device 1500 to render graphics (e.g., 3D graphics) or perform general purpose computations. For example, the GPU(s) 1508 may be used for General-Purpose computing on GPUs (GPGPU). The GPU(s) 1508 may include hundreds or thousands of cores that are capable of handling hundreds or thousands of software threads simultaneously. The GPU(s) 1508 may generate pixel data for output images in response to rendering commands (e.g., rendering commands from the CPU(s) 1506 received via a host interface). The GPU(s) 1508 may include graphics memory, such as display memory, for storing pixel data or any other suitable data, such as GPGPU data. The display memory may be included as part of the memory 1504. The GPU(s) 1508 may include two or more GPUs operating in parallel (e.g., via a link). The link may directly connect the GPUs (e.g., using NVLINK) or may connect the GPUs through a switch (e.g., using NVSwitch). When combined together, each GPU 1508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1506 and/or the GPU(s) 1508, the logic unit(s) 1520 may be configured to execute at least some of the computer-readable instructions to control one or more components of the computing device 1500 to perform one or more of the methods and/or processes described herein. In embodiments, the CPU(s) 1506, the GPU(s) 1508, and/or the logic unit(s) 1520 may discretely or jointly perform any combination of the methods, processes and/or portions thereof. One or more of the logic units 1520 may be part of and/or integrated in one or more of the CPU(s) 1506 and/or the GPU(s) 1508 and/or one or more of the logic units 1520 may be discrete components or otherwise external to the CPU(s) 1506 and/or the GPU(s) 1508. In embodiments, one or more of the logic units 1520 may be a coprocessor of one or more of the CPU(s) 1506 and/or one or more of the GPU(s) 1508.

Examples of the logic unit(s) 1520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1510 may include one or more receivers, transmitters, and/or transceivers that allow the computing device 1500 to communicate with other computing devices via an electronic communication network, included wired and/or wireless communications. The communication interface 1510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1520 and/or communication interface 1510 may include one or more data processing units (DPUs) to transmit data received over a network and/or through interconnect system 1502 directly to (e.g., a memory of) one or more GPU(s) 1508.

The I/O ports 1512 may allow the computing device 1500 to be logically coupled to other devices including the I/O components 1514, the presentation component(s) 1518, and/or other components, some of which may be built in to (e.g., integrated in) the computing device 1500. Illustrative I/O components 1514 include a microphone, mouse, keyboard, joystick, game pad, game controller, satellite dish, scanner, printer, wireless device, etc. The I/O components 1514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1500. The computing device 1500 may be include depth cameras, such as stereoscopic camera systems, infrared camera systems, RGB camera systems, touchscreen technology, and combinations of these, for gesture detection and recognition. Additionally, the computing device 1500 may include accelerometers or gyroscopes (e.g., as part of an inertia measurement unit (IMU)) that allow detection of motion. In some examples, the output of the accelerometers or gyroscopes may be used by the computing device 1500 to render immersive augmented reality or virtual reality.

The power supply 1516 may include a hard-wired power supply, a battery power supply, or a combination thereof. The power supply 1516 may provide power to the computing device 1500 to allow the components of the computing device 1500 to operate.

The presentation component(s) 1518 may include a display (e.g., a monitor, a touch screen, a television screen, a heads-up-display (HUD), other display types, or a combination thereof), speakers, and/or other presentation components. The presentation component(s) 1518 may receive data from other components (e.g., the GPU(s) 1508, the CPU(s) 1506, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1500 of FIG. 15—e.g., each device may include similar components, features, and/or functionality of the computing device(s) 1500. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1500 described herein with respect to FIG. 15. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

A: A method comprising: determining one or more first features associated with one or more first images corresponding to a localization map of an environment; generating, based at least on clustering the one or more first features using a first clustering technique, a vocabulary tree that represents one or more first visual words associated with the environment; determining one or more second features associated with one or more second images corresponding to the localization map; updating, based at least on the one or more second features and using a second clustering technique, the vocabulary tree to represent one or more second visual words associated with the environment; and providing, to one or more machines, data representative of at least one of the vocabulary tree or a vocabulary dictionary associated with the vocabulary tree, the data for performing localization of the one or more machines within the environment.

B: The method of paragraph A, wherein one of: the first clustering technique includes K-Means Clustering and the second clustering technique includes Balanced Iterative Reducing and Clustering using Hierarchies (BIRCH); or the second clustering technique includes the BIRCH and the first clustering technique includes the K-Means Clustering.

C: The method of either paragraph A or paragraph B, wherein: the one or more first images represent one or more portions of the environment during a first period of time; the one or more second images represent the one or more portions of the environment during a second period of time that is after the first period of time, and at least one first feature of the one or more first features is different than at least one second feature of the one or more second features.

D: The method of any one of paragraphs A-C, wherein: the vocabulary tree includes at least a first cluster of features from the one or more first features, the first cluster of features associated with a first visual word of the one or more first visual words; and the updating the vocabulary tree comprises: determining an updated cluster of features by at least adding a second feature of the one or more second features to the first cluster of features; determining that a radius associated with the updated cluster of features satisfies a threshold radius; and determining, based at least on the radius satisfying the threshold radius, a second cluster of features and a third cluster of features from the updated cluster of features, the second cluster of features being associated with a second visual word from the one or more second visual words and the third cluster of features being associated with a third visual word from the one or more second visual word.

E: The method of any one of paragraphs A-D, wherein: the vocabulary tree includes at least a first node that is associated with one or more first clusters of features from the one or more first features; and the updating the vocabulary tree comprises: determining, for the first node, one or more second clusters of features based at least on the one or more first clusters of features and the one or more second features; determining, based at least on the one or more second clusters of features, that a total number of clusters exceeds a threshold number; and determining, based at least on the total number of clusters exceeding the threshold number, at least a second node and a third node from the first node.

F: The method of any one of paragraphs A-E, further comprising: determining a first number of three-dimensional (3D) landmarks associated with the environment; determining one or more second numbers of 3D landmarks associated with the one or more second visual words; and determining, based at least on the first number of 3D landmarks and the one or more second numbers of 3D landmarks, one or more weights associated with the one or more second visual words.

G: The method of paragraph F, further comprising: generating, based at least on the vocabulary tree and the one or more weights, one or more descriptors associated with the one or more second images; and storing data representative of the one or more descriptors in association with the one or more second images.

H: The method of any one of paragraphs A-G, further comprising: storing data representative of one or more poses associated with at least one of the one or more first images or the one or more second images; and providing, to the one or more machines, second data representative of the one or more poses.

I: A system comprising: one or more processors to: generate, based at least on clustering one or more first features from one or more first images associated with a localization map of an environment, a vocabulary tree indicating one or more first visual words corresponding to the environment; generate, by at least updating the vocabulary tree based at least on clustering one or more second features from one or more second images associated with the localization map, an updated vocabulary tree to indicate one or more second visual words corresponding to the environment; and storing data representative of the updated vocabulary tree in association with the localization map.

J: The system of paragraph I, wherein: the clustering the one or more first features from the one or more first images uses one or more first clustering techniques; and the clustering the one or more second features from the one or more second images uses one or more second clustering techniques.

K: The system of either paragraph I or paragraph J, wherein: the one or more first images represent one or more portions of the environment during a first period of time; the one or more second images represent the one or more portions of the environment during a second period of time that is after the first period of time, and at least one first feature of the one or more first features is different than at least one second feature of the one or more second features.

L: The system of any one of paragraphs I-K, wherein: the vocabulary tree includes at least a first cluster of features from the one or more first features, the first cluster of features associated with a first visual word of the one or more first visual words; and the updated vocabulary tree is generated, at least, by: determining an updated cluster of features by at least adding a second feature of the one or more second features to the first cluster of features; determining that a radius associated with the updated cluster of features satisfies a threshold radius; and determining, based at least on the radius satisfying the threshold radius, a second cluster of features and a third cluster of features from the updated cluster of features, the second cluster of features being associated with a second visual word from the one or more second visual words and the third cluster of features being associated with a third visual word from the one or more second visual word.

M: The system of any one of paragraphs I-L, wherein: the vocabulary tree includes at least a first node that is associated with one or more first clusters of features from the one or more first features; and the updated vocabulary tree is generated, at least, by: determining, for the first node, one or more second clusters of features based at least on the one or more first clusters of features and the one or more second features; determining, based at least on the one or more second clusters of features, that a total number of clusters exceeds a threshold number; and determining, based at least on the total number of clusters exceeding the threshold number, at least a second node and a third node from the first node.

N: The system of any one of paragraphs I-M, wherein the one or more processors are further to: determine a first number of three-dimensional (3D) landmarks associated with the environment; determine one or more second numbers of 3D landmarks associated with the one or more second visual words; and determine, based at least on the first number of 3D landmarks and the one or more second numbers of 3D landmarks, one or more weights associated with the one or more second visual words.

O: The system of paragraph N, wherein the one or more processors are further to store, in association with the updated vocabulary tree, data representative of the one or more weights associated with the one or more second visual words.

P: The system of paragraph N, wherein the one or more processors are further to: generate, based at least on the vocabulary tree and the one or more weights, one or more descriptors associated with the one or more second images; and store second data representative of the one or more descriptors in association with the localization map.

Q: The system of paragraph N, wherein the one or more processors is further to: receive image data obtained using one or more sensors of a machine, the image data representative of one or more third images of the environment; determine, based at least on the updated vocabulary tree and the one or more weights, one or more descriptors associated with the one or more third images; and retrieve, based at least on the one or more descriptors, at least an image of the one or more second images for performing localization.

R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

S: One or more processors comprising: processing circuitry to: generate, based at least on one or more images associated with a localization map for an environment, a vocabulary dictionary that indicates at least one or more visual words associated with the environment; determine, based at least on the one or more images, a first number of three-dimensional (3D) landmarks associated with the environment; determine one or more second numbers of 3D landmarks that are associated with the one or more visual words; determine, based at least on the first number of 3D landmarks and the one or more second numbers of 3D landmarks, one or more weights associated with the one or more visual words; and store data representative of the one or more weights in association with the localization map.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

AA: A method comprising: receiving image data representing at least a left image obtained using a first sensor of a right image obtained using a second sensor of a machine; determining that at least one of the left image or the right image is related to a map image associated with a localization map of an environment; determining at least a first relative pose between the left image and the map image and a second relative pose between the right image and the map image; determining, based at least on the first relative pose and the second relative pose, a localized pose associated with the machine within the environment; and causing the machine to perform one or more operations based at least on the localized pose.

AB: The method of paragraph AA, further comprising: determining, based at least on the first relative pose and the second relative pose, a predicted pose between at least one of the left image and the map image or the right image and the map image, wherein the determining the localized pose associated with the machine is based at least on the predicted pose.

AC: The method of paragraph AB, further comprising: determining a map pose associated with the map image, wherein the determining the localized pose associated with the machine is further based at least on the map pose.

AD: The method of any one of paragraphs AA-AC, further comprising: determining, based at least on calibration data associated with the first sensor and the second sensor, a third relative pose between the left image and the right image, wherein the determining the localized pose associated with the machine is further based at least on the third relative pose.

AE: The method of paragraph AD, wherein: the first relative pose includes a first translation scale factor between the left image and the map image; the second relative pose includes a second translation scale factor between the right image and the map image; and the third relative pose includes a calibrated translation scale between the left image and the right image.

AF: The method of paragraph AE, wherein the determining the localized pose associated with the machine comprises: determining, based at least on optimizing the third relative pose with respect to the first relative pose and the second relative pose, a first predicted pose between the left image and the map image that includes a first estimated translation scale and a second predicted pose between the right image and the map image that includes a second estimated translation scale; and determining the localized pose associated with the machine based at least on at least one of the first predicted pose and the second predicted pose.

AG: The method of any one of paragraphs AA-AF, wherein the determining the first relative pose and the second relative pose comprises: determining, based at least on one or more first feature matches between the left image and the map image, a first essential matrix associated with the left image and the map image; determining the first relative pose based at least on the first essential matrix; determining, based at least on one or more second feature matches between the right image and the map image, a second essential matrix associated with the right image and the map image; and determining the second relative pose based at least on the second essential matrix.

AH: The method of any one of paragraphs AA-AG, further comprising: determining, based at least on the left image and the map image, one or more first distances between one or more first points of the left image and one or more first epipolar lines; and determining, based at least on the right image and the map image, one or more second distances between one or more second points in the right image and one or more second epipolar lines, wherein the determining the localized pose associated with the machine is further based at least on the one or more first distances and the one or more second distances.

AI: The method of paragraph AH, further comprising: determining, based at least on the first relative pose and the second relative pose, a first predicted pose between the left image and the map image and a second predicted pose between the right image and the map image; and determining, based at least on the one or more first distances and the one or more second distances, a first refined pose associated with the first predicted pose and a second refined pose associated with the second predicted pose, wherein the determining the localized pose associated with the machine is based at least on the first refined pose and the second refined pose.

AJ: A system comprising: one or more processors to: obtain image data using one or more image sensors of a machine, the image data representative of images corresponding to an environment; determine that at least one of the images is associated with a map image of a localization map corresponding to the environment; determine relative poses between the images and the map image; determine, based at least on the relative poses, a localized pose associated with the machine within the environment; and cause the machine to perform one or more operations based at least on the localized pose.

AK: The system of paragraph AJ, wherein the one or more processors are further to: determine, based at least on the relative poses, a predicted pose between at least one of the images and the map image, wherein the localized pose associated with the machine is determined based at least on the predicted pose.

AL: The system of paragraph AK, wherein the one or more processors are further to: determine a map pose associated with the map image, wherein the localized pose associated with the machine is further determined based at least on the map pose.

AM: The system of any one of paragraphs AJ-AL, wherein the one or more processors are further to: determine, based at least on calibration data associated with the one or more image sensors, a second relative pose between the images, wherein the localized pose associated with the machine is further determined based at least on the second relative pose.

AN: The system of paragraph AM, wherein: the relative poses include translation scale factors between the images and the map image; and the second relative pose includes a calibrated translation scale between the images.

AO: The system of paragraph AN, wherein the determination of the localized pose associated with the machine comprises: determining, based at least on optimizing the second relative pose with respect to the relative poses, predicted poses between the images and the map image that include estimated translation scales; and determining the localized pose associated with the machine based at least on the predicted poses.

AP: The system of any one of paragraphs AJ-AO, wherein the determination of the relative poses between the images and the map image comprises: determining feature matches between the images and the map image; determining, based at least on feature matches, essential matrices associated with the images and the map image; and determining the relative poses based at least on the essential matrices.

AQ: The system of any one of paragraphs AJ-AP, wherein the one or more processors is further to: determine, based at least on the relative poses, one or more first distances between one or more points of the images and one or more epipolar lines corresponding to the one or more points, wherein the localized pose associated with the machine is determined based at least on the one or more distances.

AR: The system of any one of paragraphs AJ-AQ, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

AS: One or more processors comprising: processing circuitry to: determine first relative poses between images obtained using image sensors of a machine and one or more map images associated with a localization map of an environment; determine one or more second relative poses between one or more pairs of the images; determine, based at least on the first relative poses and the one or more second relative poses, a localized pose associated with the machine within the environment; and cause the machine to perform one or more operations based at least on the localized pose.

AT: The one or more processors of paragraph AS, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving image data representing at least a left image obtained using a first sensor of a right image obtained using a second sensor of a machine;
determining that at least one of the left image or the right image is related to a map image associated with a localization map of an environment;
determining at least a first relative pose between the left image and the map image and a second relative pose between the right image and the map image;
determining, based at least on the first relative pose and the second relative pose, a localized pose associated with the machine within the environment; and
causing the machine to perform one or more operations based at least on the localized pose.

2. The method of claim 1, further comprising:
determining, based at least on the first relative pose and the second relative pose, a predicted pose between at least one of the left image and the map image or the right image and the map image,
wherein the determining the localized pose associated with the machine is based at least on the predicted pose.

3. The method of claim 2, further comprising:
determining a map pose associated with the map image,
wherein the determining the localized pose associated with the machine is further based at least on the map pose.

4. The method of claim 1, further comprising:
determining, based at least on calibration data associated with the first sensor and the second sensor, a third relative pose between the left image and the right image,
wherein the determining the localized pose associated with the machine is further based at least on the third relative pose.

5. The method of claim 4, wherein:
the first relative pose includes a first translation scale factor between the left image and the map image;
the second relative pose includes a second translation scale factor between the right image and the map image; and
the third relative pose includes a calibrated translation scale between the left image and the right image.

6. The method of claim 5, wherein the determining the localized pose associated with the machine comprises:
determining, based at least on optimizing the third relative pose with respect to the first relative pose and the second relative pose, a first predicted pose between the left image and the map image that includes a first estimated translation scale and a second predicted pose between the right image and the map image that includes a second estimated translation scale; and
determining the localized pose associated with the machine based at least on at least one of the first predicted pose and the second predicted pose.

7. The method of claim 1, wherein the determining the first relative pose and the second relative pose comprises:
determining, based at least on one or more first feature matches between the left image and the map image, a first essential matrix associated with the left image and the map image;
determining the first relative pose based at least on the first essential matrix;
determining, based at least on one or more second feature matches between the right image and the map image, a second essential matrix associated with the right image and the map image; and
determining the second relative pose based at least on the second essential matrix.

8. The method of claim 1, further comprising:
determining, based at least on the left image and the map image, one or more first distances between one or more first points of the left image and one or more first epipolar lines; and
determining, based at least on the right image and the map image, one or more second distances between one or more second points in the right image and one or more second epipolar lines,
wherein the determining the localized pose associated with the machine is further based at least on the one or more first distances and the one or more second distances.

9. The method of claim 8, further comprising:
determining, based at least on the first relative pose and the second relative pose, a first predicted pose between the left image and the map image and a second predicted pose between the right image and the map image; and
determining, based at least on the one or more first distances and the one or more second distances, a first refined pose associated with the first predicted pose and a second refined pose associated with the second predicted pose,
wherein the determining the localized pose associated with the machine is based at least on the first refined pose and the second refined pose.

10. A system comprising:
one or more processors to:
obtain image data using one or more image sensors of a machine, the image data representative of images corresponding to an environment;
determine that at least one of the images is associated with a map image of a localization map corresponding to the environment;
determine relative poses between the images and the map image;
determine, based at least on the relative poses, a localized pose associated with the machine within the environment; and
cause the machine to perform one or more operations based at least on the localized pose.

11. The system of claim 10, wherein the one or more processors are further to:
determine, based at least on the relative poses, a predicted pose between at least one of the images and the map image,
wherein the localized pose associated with the machine is determined based at least on the predicted pose.

12. The system of claim 11, wherein the one or more processors are further to:
determine a map pose associated with the map image,
wherein the localized pose associated with the machine is further determined based at least on the map pose.

13. The system of claim 10, wherein the one or more processors are further to:
determine, based at least on calibration data associated with the one or more image sensors, a second relative pose between the images,
wherein the localized pose associated with the machine is further determined based at least on the second relative pose.

14. The system of claim 13, wherein:
the relative poses include translation scale factors between the images and the map image; and
the second relative pose includes a calibrated translation scale between the images.

15. The system of claim 14, wherein the determination of the localized pose associated with the machine comprises:
determining, based at least on optimizing the second relative pose with respect to the relative poses, predicted poses between the images and the map image that include estimated translation scales; and
determining the localized pose associated with the machine based at least on the predicted poses.

16. The system of claim 10, wherein the determination of the relative poses between the images and the map image comprises:
determining feature matches between the images and the map image;
determining, based at least on feature matches, essential matrices associated with the images and the map image; and
determining the relative poses based at least on the essential matrices.

17. The system of claim 10, wherein the one or more processors is further to:
determine, based at least on the relative poses, one or more first distances between one or more points of the images and one or more epipolar lines corresponding to the one or more points,
wherein the localized pose associated with the machine is determined based at least on the one or more distances.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
determine first relative poses between images obtained using image sensors of a machine and one or more map images associated with a localization map of an environment;
determine one or more second relative poses between one or more pairs of the images;
determine, based at least on the first relative poses and the one or more second relative poses, a localized pose associated with the machine within the environment; and
cause the machine to perform one or more operations based at least on the localized pose.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
